(19) United States
(12) Patent Application Publication
(10) Pub. No.: US 2026/0082440 A1
(43) Pub. Date: Mar. 19, 2026

(54) INFORMATION PROCESSING APPARATUS, CONTROL METHOD, AND NON-TRANSITORY COMPUTER-READABLE STORAGE MEDIUM STORING PROGRAM

(71) Applicant: CANON KABUSHIKI KAISHA, Tokyo (JP)

(72) Inventor: Haruna Sato, Tokyo (JP)

(21) Appl. No.: 19/324,376

(22) Filed: Sep. 10, 2025

(30) Foreign Application Priority Data
Sep. 17, 2024 (JP) 2024-160326

(51) Int. Cl. H04W 76/14; G06F 3/12; H04L 67/00

(52) U.S. Cl. CPC H04W 76/14; G06F 3/1204; G06F 3/1225; G06F 3/1236; G06F 3/1292; H04L 67/34

(57) ABSTRACT

An information processing apparatus controls to execute, based on that the acquired information corresponding to the model name of the communication apparatus is first contents, predetermined processing for establishing direct connection which directly connects the information processing apparatus and the communication apparatus, and execute, based on that the acquired information corresponding to the model name of the communication apparatus is second contents different from the first contents, processing for establishing infrastructure connection which connects the information processing apparatus and the communication apparatus via an external apparatus different from the information processing apparatus and the communication apparatus without executing the predetermined processing.

### BACKGROUND

### Field of the Technology

The present disclosure relates to an information processing apparatus, a control method, and a non-transitory computer-readable storage medium storing a program.

### Description of the Related Art

The connection form for connecting an information processing apparatus (to be referred to as a PC hereinafter) to a network adaptive printing apparatus (to be referred to as a printer hereinafter) includes infrastructure connection and direct connection. The infrastructure connection is a form in which the PC and the printer are connected in a communication-enabling manner via an access point (to be referred to as an AP hereinafter) of an external apparatus such as a wireless LAN router. On the other hand, the direct connection is a form in which the PC is connected in a communication-enabling manner directly to the printer without intervention of an AP. For example, in a case where the printer has an internal AP function, by connecting the PC to the internal AP of the printer, the PC can communicate with the printer by direct connection. Japanese Patent Laid-Open No. 2016-127545 describes a method of deciding the connection form between a PC and a printer in accordance with whether the PC is connected to an AP, and setting up the printer.

### SUMMARY

The present disclosure provides an information processing apparatus that performs setting of the optimal wireless connection for a communication apparatus when performing setting of wireless connection to the communication apparatus, a control method, and a non-transitory computer-readable storage medium storing a program.

A control method according to the present disclosure in one aspect provides a control method comprising: performing setting of wireless connection of a communication apparatus to enable communication between an information processing apparatus and the communication apparatus; acquiring information corresponding to a model name of the communication apparatus from the communication apparatus targeted for setting of wireless connection of the communication apparatus; and controlling to execute, based on that the acquired information corresponding to the model name of the communication apparatus is first contents, predetermined processing for establishing direct connection which directly connects the information processing apparatus and the communication apparatus, and execute, based on that the acquired information corresponding to the model name of the communication apparatus is second contents different from the first contents, processing for establishing infrastructure connection which connects the information processing apparatus and the communication apparatus via an external apparatus different from the information processing apparatus and the communication apparatus without executing the predetermined processing..

Features of the present disclosure will become apparent from the following description of embodiments with reference to the attached drawings. The following description of embodiments are described by way of example.

### BRIEF DESCRIPTION OF THE DRAWINGS

FIG. 1 is a view showing the configuration of a system;

FIG. 2 is a block diagram showing the configurations of apparatuses;

FIGS. 3A and 3B are flowcharts illustrating processing in an information processing apparatus;

FIG. 4 is a flowchart illustrating processing in the information processing apparatus;

FIG. 5 is a flowchart illustrating processing in the information processing apparatus;

FIG. 6 is a flowchart illustrating processing in a communication apparatus;

FIGS. 7A and 7B are flowcharts illustrating processing in an information processing apparatus;

FIG. 8 is a flowchart illustrating processing in the information processing apparatus;

FIG. 9 is a flowchart illustrating processing in the information processing apparatus;

FIG. 10 is a flowchart illustrating processing in the information processing apparatus;

FIGS. 11A and 11B are views each showing a file to be downloaded from a server;

FIGS. 12A to 12D are views each showing a user interface screen; and

FIGS. 13A to 13D are views each showing a user interface screen.

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made the disclosure that requires all such features, and multiple such features may be combined as appropriate. Furthermore, in the attached drawings, the same reference numerals are given to the same or similar configurations, and redundant description thereof is omitted.

When performing setting of wireless connection to a communication apparatus, there is a need to perform setting of the optimal wireless connection for the communication apparatus.

According to the present disclosure, when performing setting of wireless connection to a communication apparatus, it is possible to perform setting of the optimal wireless connection for the communication apparatus.

### First Embodiment

An information processing apparatus and a communication apparatus included in a communication system according to this embodiment will be described. The information processing apparatus is also referred to as a terminal apparatus. In this embodiment, a smartphone is exemplified as the information processing apparatus, but the information processing apparatus is not limited thereto. For example, various kinds of apparatuses such as a personal computer (PC), a tablet terminal, a Personal Digital Assistance (PDA), and a digital camera are applicable as the information processing apparatus. In this embodiment, a printer is exemplified as the communication apparatus. The printer may be an inkjet printer that performs printing using ink, or a laser beam printer that performs printing using toner. The printer may be a full-color printer capable of color printing, or a monochrome printer incapable of color printing but capable of monochrome printing. Note that in this embodiment, the communication apparatus is not limited to the printer, and any apparatus is applicable as the communication apparatus as long as it can perform wireless communication with the information processing apparatus. The communication apparatus is also applicable to, for example, a copying machine, a facsimile apparatus, a scanner, a smartphone, a PC, a tablet terminal, a PDA, a digital camera, a music playback device, a television, a smart speaker, a robot cleaner, an automatic cooking pot, a refrigerator, and the like. In addition, the communication apparatus is applicable to, for example, a multi-function peripheral having a plurality of functions such as a copying function, a FAX function, a printing function, and the like.

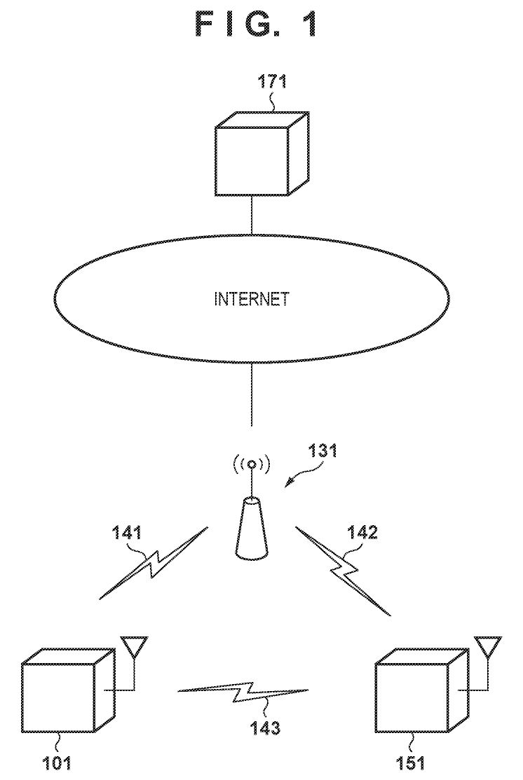

First, the system configuration for implementing this embodiment will be described. FIG. 1 is a view showing an example of the configuration of a communication system according to this embodiment. This system includes a communication apparatus 151, an information processing apparatus 101, an access point (AP) 131, and an external server 171.

The information processing apparatus 101 is the information processing apparatus according to this embodiment. The communication apparatus 151 is the communication apparatus according to this embodiment. The AP 131 is an access point activated by an external apparatus existing outside the information processing apparatus 101 and the communication apparatus 151. The external apparatus is, for example, a wireless Local Area Network (LAN) router. The external server 171 is a server that can provide an apparatus connected to the AP 131 with a service via the Internet.

In a state in which the communication apparatus 151 and the information processing apparatus 101 are connected to the AP 131, the LAN formed by the AP 131 includes the AP 131, the communication apparatus 151, and the information processing apparatus 101. On the other hand, the Wide Area Network (WAN) includes the AP 131 and the external server 171.

In this embodiment, when infrastructure connection (to be described later) is established, the information processing apparatus 101 can communicate with the communication apparatus 151 via the AP 131. Furthermore, when direct connection (to be described later) is established, the information processing apparatus 101 can directly communicate with the communication apparatus 151 without intervention of the AP 131. Note that in the following description, a connection with the AP corresponds to a connection with the network formed by the AP. Note that one external apparatus may activate a plurality of APs and be capable of forming a plurality of networks at the same time.

In this embodiment, each of a connection 141 between the information processing apparatus 101 and the AP 131 and a connection 142 between the communication apparatus 151 and the AP 131 is a connection using a communication method based on the IEEE 802.11 series standard. More specifically, the communication method based on the IEEE 802.11 series standard is Wireless Fidelity (Wi-Fi)^{®}. A connection 143 between the information processing apparatus 101 and the communication apparatus 151 is also a connection using a communication method based on the IEEE 802.11 series standard. However, the communication method used for the connection 143 is not limited to this form, and may be, for example, Bluetooth^{®} Low Energy (BLE), Bluetooth Classic, Wi-Fi Aware, Near Field Communication (NFC), or the like. The AP 131 and the external server 171 can communicate via the Internet. While the AP 131 is connected to the Internet, the apparatuses (the information processing apparatus 101 and the communication apparatus 151) connected to the AP 131 can also use the Internet. Note that each of the connection 141 between the information processing apparatus 101 and the AP 131 and the connection 142 between the communication apparatus 151 and the AP 131 may be a wired LAN connection.

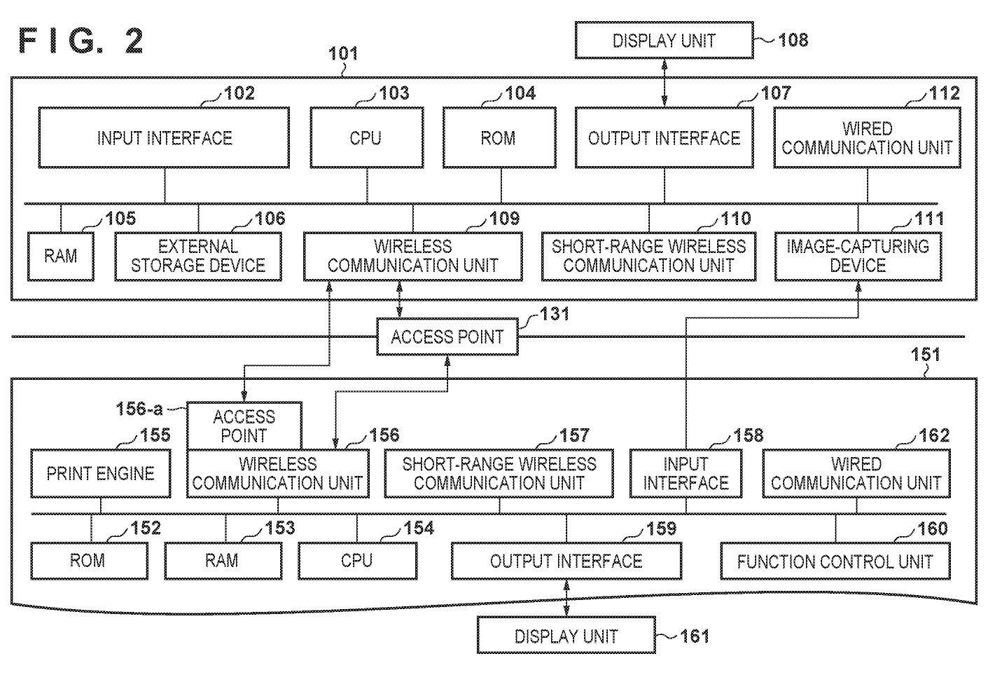

Next, the configuration of the information processing apparatus according to this embodiment, and the configuration of the communication apparatus that can communicate with the information processing apparatus according to this embodiment will be described with reference to the block diagram of FIG. 2. The following configurations will be exemplified in this embodiment, but this embodiment is applicable to an apparatus that can communicate with a communication apparatus and, in particular, functions are not limited to those shown in FIG. 2.

The information processing apparatus 101 includes an input interface 102, a CPU 103, a ROM 104, a RAM 105, an external storage device 106, an output interface 107, a display unit 108, a wireless communication unit 109, a short distance wireless communication unit 110, an image capturing device 111, a wired communication unit 112, and the like. The CPU 103, the ROM 104, the RAM 105, and the like form the computer of the information processing apparatus 101.

The input interface 102 is an interface capable of accepting a data input and an operation instruction from the user, and is formed by a physical keyboard, buttons, a touch panel, and the like. Note that the output interface 107 (to be described later) and the input interface 102 may have the same configuration, and output of a screen and acceptance of an operation from the user may be done by the same configuration.

The CPU 103 is a system control unit, and controls the overall information processing apparatus 101. In this embodiment, the CPU 103 executes control of (display control) of display contents on the display unit 108.

The ROM 104 stores permanent data such as control programs to be executed by the CPU 103, data tables, and an operating system (to be referred to as an OS hereinafter) program. In this embodiment, the control programs stored in the ROM 104 perform software execution control such as scheduling, task switch, and interrupt processing under the management of the embedded OS stored in the ROM 104. In this embodiment, the ROM 104 stores a predetermined application program (application) for controlling the communication apparatus 151. In other words, the application program is application software. The predetermined application is externally installed in the information processing apparatus 101 by, for example, a store application for installing various applications. The predetermined application is an application provided by the vender of the communication apparatus 151, and used to perform connection setting of the communication apparatus 151 by communicating with the communication apparatus 151. Note that the predetermined application may have another function other than the function of performing connection setting of the communication apparatus 151. More specifically, another function is, for example, a function of transmitting a print job for causing the communication apparatus 151 to execute printing (print job transmission function), or a function of transmitting a scan job for causing the communication apparatus 151 to execute scanning (scan job transmission function). Note that the processing described as the processing executed by the OS in this embodiment is, to be precise, the processing executed by the CPU 103 in accordance with the program in the OS. Similarly, the processing described as the processing executed by the application is, to be precise, the processing executed by the CPU 103 in accordance with the program in the application.

The RAM 105 is formed by a Static Random Access Memory (SRAM) or the like, which needs a backup power supply. Note that the RAM 105 can store important data such as program control variables without volatilization because the data are held by a primary battery (not shown) for data backup. In addition, a memory area for storing setting information of the information processing apparatus 101, management data of the information processing apparatus 101, and the like is also provided in the RAM 105. Furthermore, the RAM 105 is also used as the main memory and work memory of the CPU 103.

The external storage device 106 has various programs such as a print information generation program for generating print information interpretable by the communication apparatus 151, and an information transmission/reception control program for performing transmission/reception to/from the communication apparatus 151 connected via the wireless communication unit 109. The external storage device 106 also saves various kinds of information to be used by these programs, and image data obtained from another information processing apparatus or the Internet.

The output interface 107 is an interface that performs control for causing the display unit 108 to perform display of data and notification of the state of the information processing apparatus 101.

The display unit 108 is formed by a Light Emitting Diode (LED), a Liquid Crystal Display (LCD), or the like, and performs display of data and notification of the state of the information processing apparatus 101. Note that a software keyboard including keys such as numerical input keys, a mode setting key, an OK key, a cancel key, and a power key may be provided on the display unit 108 so that an input from the user is accepted via the display unit 108. In this embodiment, the display unit 108 is a touch panel and can accept an operation by a finger, a pen, or the like from the user.

The wireless communication unit 109 is configured to be wirelessly connected to an apparatus such as the communication apparatus 151 or the AP 131 to execute data communication. For example, the wireless communication unit 109 may directly communicate with the communication apparatus 151 by wireless communication, or may communicate therewith via the AP 131 existing outside the information processing apparatus 101 and the communication apparatus 151. As the wireless communication method of the wireless communication unit 109, Wi-Fi, which is the communication method based on the IEEE 802.11 standard, is used in this embodiment, but Bluetooth Classic or the like may be used. In this embodiment, the wireless LAN is a Wi-Fi network. Note that in this embodiment, connection by a method of connecting the information processing apparatus 101 and the communication apparatus 151 directly without intervention of the external access point is referred to as direct connection. Connection by a method of connecting the information processing apparatus 101 and the communication apparatus 151 via an external AP is referred to as infrastructure connection.

The short distance wireless communication unit 110 is configured to execute data communication with an apparatus such as the communication apparatus 151 by a short distance wireless communication method, and performs communication by a communication method different from that of the wireless communication unit 109. The short distance wireless communication unit 110 can be connected to a short distance wireless communication unit 157 in the communication apparatus 151. Note that examples of the communication method of the short distance wireless communication unit 110 are, BLE, Bluetooth Classic, Wi-Fi Aware, NFC, and the like.

The image capturing device 111 is a device that converts an image captured by an image sensor into digital data. The digital data is temporarily stored in the RAM 105. Then, the digital data is converted into a predetermined image format by a program executed by the CPU 103, and saved as image data in the external storage device 106.

The wired communication unit 112 is configured to be connected, via a wire, to an apparatus such as the communication apparatus 151 or the AP 131 to execute data communication. For example, the wired communication unit 112 performs communication via a wired LAN. In this embodiment, the communication in the wired LAN uses the Ethernet standard. Note that the wired communication unit 112 is not limited to this form, and may perform communication via, for example, a Universal Serial Bus (USB) cable. For example, if the information processing apparatus 101 is a smartphone, the information processing apparatus 101 may not include the wired communication unit 112.

The communication apparatus 151 includes a ROM 152, a RAM 153, a CPU 154, a print engine 155, a wireless communication unit 156, the short distance wireless communication unit 157, an input interface 158, an output interface 159, a function control unit 160, a display unit 161, a wired communication unit 162, and the like. The ROM 152, the RAM 153, the CPU 154, and the like form the computer of the communication apparatus 151.

The wireless communication unit 156 is configured to be wirelessly connected to an apparatus such as the information processing apparatus 101 or the AP 131 to execute data communication. As the wireless communication method of the wireless communication unit 156, Wi-Fi, which is the communication method based on the IEEE 802.11 standard, is used in this embodiment, but Bluetooth Classic or the like may be used. Note that the wireless communication unit 156 includes, as an internal AP of the communication apparatus 151, an AP 156-a which is used to connect to an apparatus such as the information processing apparatus 101. Note that this AP can be connected to the wireless communication unit 109 of the information processing apparatus 101. Note that the wireless communication unit 156 may directly communicate with the information processing apparatus 101 via the AP 156-a, or may communicate with the information processing apparatus 101 via the AP 131. The AP 156-a may be hardware functioning as an AP, or the wireless communication unit 156 may be operated as the AP 156-a by software for causing it to function as an AP. The communication apparatus 151 may be capable of activating therein a plurality of APs having different Service Set Identifiers (SSIDs) or passwords.

The RAM 153 is formed by a DRAM or the like that needs a backup power supply. Note that the RAM 153 can store important data such as program control variables without volatilization because the data are held by supplying power (not shown) for data backup. Furthermore, the RAM 153 is used as the main memory and work memory of the CPU 154, and operates as a reception buffer for temporarily saving print information received from the information processing apparatus 101 or the like to save various kinds of information.

The ROM 152 stores permanent data such as control programs to be executed by the CPU 154, data tables, and an OS program. In this embodiment, the respective control programs stored in the ROM 152 perform software execution control such as scheduling, task switch, and interrupt processing under the management of the embedded OS stored in the ROM 152. In addition, a memory area that stores data necessary to be held even when no power is supplied, such as setting information of the communication apparatus 151 and management data of the communication apparatus 151, is also provided in the ROM 152.

The CPU 154 is a system control unit, and controls the overall communication apparatus 151.

Based on the information saved in the RAM 153 or a print job received from the information processing apparatus 101 or the like, the print engine 155 forms an image on a print medium such as a paper sheet using a printing material such as ink and outputs the print result. At this time, the print job transmitted from the information processing apparatus 101 or the like has a large transmission data amount, and high-speed communication is required. Thus, the print engine 155 receives the print job via the wireless communication unit 156 capable of performing communication at a higher speed than the short distance wireless communication unit 157.

The short distance wireless communication unit 157 is configured to perform communication with an apparatus such as the information processing apparatus 101 by a short distance wireless communication method. Note that examples of the communication method of the short distance wireless communication unit 157 are BLE, Bluetooth Classic, Wi-Fi Aware, and the like.

The input interface 158 is an interface capable of accepting a data input and an operation instruction from the user, and is formed by a physical keyboard, buttons, a touch panel, and the like. Note that the output interface 159 (to be described later) and the input interface 158 may have the same configuration, and output of a screen and acceptance of an operation from the user may be done by the same configuration. The output interface 159 is an interface that performs control for causing the display unit 161 to perform display of data and notification of the state of the communication apparatus 151.

The function control unit 160 manages the function operation as to whether to operate each function of the communication apparatus 151.

The display unit 161 is formed by a Light Emitting Diode (LED), a Liquid Crystal Display (LCD), or the like, and performs display of data and notification of the state of the communication apparatus 151. Note that a software keyboard including keys such as numerical input keys, a mode setting key, an OK key, a cancel key, and a power key may be provided on the display unit 161 so that an input from the user is accepted via the display unit 161.

The wired communication unit 162 is configured to be connected, via a wire, to an apparatus such as the information processing apparatus 101 or the AP 131 to execute data communication. For example, the wired communication unit 162 performs communication via a wired LAN. Note that the wired communication unit 162 is not limited to this form, and may perform communication via, for example, a USB cable.

### Direct Connection Method

Direct connection indicates a form in which apparatuses are wirelessly connected directly (that is, by Peer to Peer) without intervention of an external apparatus such as the AP 131. Direct connection is also called Peer to Peer connection (P2P connection). As one connection mode, the communication apparatus 151 can operate in a mode (direct connection mode) for communication by direct connection. In Wi-Fi communication, the mode for communication by direct connection includes a plurality of modes such as a software AP mode and a Wi-Fi Direct (WFD) mode.

A mode in which direct connection is executed by WFD is called a WFD mode. WFD is a standard developed by Wi-Fi Alliance and is a standard included in the IEEE 802.11 series communication standards. In the WFD mode, a device serving as a communication partner is searched for by a device search command, then the roles of a P2P group owner (GO) and P2P client are decided, and remaining wireless connection processing is performed. The group owner corresponds to a Wi-Fi master station (master unit), and the client corresponds to a Wi-Fi slave station (slave unit). This role making corresponds to, for example, GO Negotiation in P2P. Note that in the WFD mode in a state before role making is performed, the communication apparatus 151 is neither the master station nor the slave station. More specifically, first, one of devices to communicate with each other issues a device search command and searches for a device to be connected in the WFD mode. After the other device serving as a communication partner is discovered, the devices confirm information about services and functions that can be supplied by the respective devices. Note that the device supply information confirmation is an option and is dispensable. The device supply information confirmation phase corresponds to, for example, P2P Provision Discovery. Then, the devices confirm the device supply information and decide, as roles, which device serves as a P2P client and which device serves as a P2P group owner. After the client and the group owner are decided, the devices exchange parameters for performing WFD communication. Based on the exchanged parameters, the P2P client and the P2P group owner perform remaining wireless connection processing and IP connection processing. Note that in the WFD mode, the communication apparatus 151 may always operate as the GO without executing the above-described GO Negotiation. That is, the communication apparatus 151 may operate in the WFD mode that is an Autonomous GO mode. The state in which the communication apparatus 151 operates in the WFD mode is, for example, a state in which WFD connection is not established but the communication apparatus 151 operates as the GO, or a state in which WFD connection is established and the communication apparatus 151 operates as the GO.

In the software AP mode, one device (for example, the information processing apparatus 101) among devices (for example, the information processing apparatus 101 and the communication apparatus 151) to communicate with each other serves as a client that plays a role of requesting various services. The other device implements the function of an AP in Wi-Fi by software setting. The software AP corresponds to a Wi-Fi master station, and the client corresponds to a Wi-Fi slave station. In the software AP mode, the client searches for a device serving as a software AP by a device search command. After the software AP is discovered, the client and the software AP perform remaining wireless connection processing (establishment of wireless connection and the like) and then IP connection processing (assignment of an IP address and the like). Note that commands and parameters transmitted/received when implementing wireless connection between the client and the software AP suffice to be those defined by the Wi-Fi standard, and a description thereof will be omitted here.

In this embodiment, in a case where the communication apparatus 151 establishes and maintains direct connection, it operates as a master station in a network to which the communication apparatus 151 belongs. Note that the master station is an apparatus that creates a wireless network, and is an apparatus that provides a slave station with parameters used in connection to the wireless network. The parameters used in connection to the wireless network are, for example, parameters about a channel used by the master station. The slave station receives the parameters and is then connected to the wireless network created by the master station using the channel used by the master station. In the direct connection mode, the communication apparatus 151 operates as the master station so that the communication apparatus 151 can thus decide a specific frequency band and channel to be used for communication in the direct connection mode. In this embodiment, the communication apparatus 151 can use a channel corresponding to the 2.4-GHz frequency band and a channel corresponding to the 5-GHz frequency band for communication in the direct connection mode.

### Infrastructure Connection Method

Infrastructure connection is a connection form in which devices (for example, the information processing apparatus 101 and the communication apparatus 151) to communicate with each other are connected to an AP (for example, the AP 131) that controls a network of the devices, and the devices communicate with each other via the AP. As one connection mode, the communication apparatus 151 can also operate in a mode (infrastructure connection mode) for communication by infrastructure connection.

In infrastructure connection, each device searches for an AP by a device search command. After an AP is discovered, the device and the AP perform remaining wireless connection processing (establishment of wireless connection and the like) and then IP connection processing (assignment of an IP address and the like). Note that commands and parameters transmitted/received when implementing wireless connection between the device and the AP suffice to be those defined by the Wi-Fi standard, and a description thereof will be omitted here.

In this embodiment, when the communication apparatus 151 operates in the infrastructure connection, the AP 131 operates as a master station and the communication apparatus 151 operates as a slave station. That is, in this embodiment, infrastructure connection means connection between the communication apparatus 151 operating as a slave station and the apparatus operating as a master station. In a case where the communication apparatus 151 establishes infrastructure connection and the information processing apparatus 101 also establishes infrastructure connection to the AP 131, the communication apparatus 151 and the information processing apparatus 101 can communicate with each other via the AP 131. Since the AP 131 decides a channel to be used for communication in infrastructure connection, the communication apparatus 151 executes communication in infrastructure connection using the channel decided by the AP 131. In this embodiment, the communication apparatus 151 can use a channel corresponding to the 2.4-GHz frequency band and a channel corresponding to the 5-GHz frequency band for communication in infrastructure connection. Note that the communication apparatus 151 can also use a channel corresponding to the DFS band in the 5-GHz frequency band for communication in infrastructure connection. Note also that to communicate with the communication apparatus 151 via the AP 131, the information processing apparatus 101 recognizes/specifies that the communication apparatus 151 belongs to a network which is formed by the AP 131 and to which the information processing apparatus 101 belongs.

### Connection Setting processing

According to this embodiment, by using wireless communication between the information processing apparatus 101 and the communication apparatus 151, the information processing apparatus 101 executes connection setting processing (setup processing) as setting for operating the communication apparatus 151 by at least one communication method out of the infrastructure connection method and the direct connection method. The connection setting processing according to this embodiment is executed by wireless communication, and is thus called a cableless setup (CLS) or wireless setup processing. Note that the connection setting processing may be executed by wired communication. In a case where a predetermined application stored in the external storage device 106 or the like is activated, the information processing apparatus 101 performs the connection setting processing for the communication apparatus 151. The communication apparatus 151 can operate in a connection setting mode (connection setting state) as a mode for executing the connection setting processing, and executes the connection setting processing in a state in which the communication apparatus 151 operates in the connection setting mode to be described later. Details of the connection setting mode will be described later.

When operating the communication apparatus 151 in the infrastructure connection mode, the information processing apparatus 101 wirelessly transmits, to the communication apparatus 151, infrastructure connection setting information as setting information for operating the communication apparatus 151 in the infrastructure connection mode. The infrastructure connection setting information includes information concerning the AP 131. The information concerning the AP 131 is, for example, information concerning a Service Set Identifier (SSID), a password, and a frequency band.

On the other hand, when operating the communication apparatus 151 in the direct connection mode, the information processing apparatus 101 wirelessly transmits, to the communication apparatus 151, direct connection setting information as setting information for operating the communication apparatus 151 in the direct connection mode. The direct connection setting information includes an instruction to enable the WFD function to operate the communication apparatus 151 as a group owner or to enable the access point setting of the communication apparatus 151. The information processing apparatus 101 acquires, from the communication apparatus 151, connection information used to perform direct connection to the communication apparatus 151. The connection information used to perform direct connection to the communication apparatus 151 includes, for example, information of the SSID, password, and the like of the communication apparatus 151 that operates in the direct connection mode.

In this embodiment, in the connection setting processing, to transmit the infrastructure connection setting information or the direct connection setting information and acquire the information used to perform direct connection to the communication apparatus 151, direct connection for connection setting between the information processing apparatus 101 and the communication apparatus 151 is used. Then, in this embodiment, the connection setting processing using Wi-Fi is executed as direct connection for connection setting. However, for example, a wireless communication standard other than Wi-Fi, such as Bluetooth Classic or Bluetooth Low Energy may be used. Alternatively, a wired communication standard such as a wired LAN or Universal Serial Bus (USB) may be used as direct connection for connection setting. In these forms, the information processing apparatus 101 may maintain the Wi-Fi connection with the AP even while establishing a connection between the information processing apparatus 101 and the communication apparatus 151 operating in the connection setting mode.

After infrastructure connection by Wi-Fi or direct connection is established between the information processing apparatus 101 and the communication apparatus 151 by the connection setting processing, the information processing apparatus 101 and the communication apparatus 151 can communicate with each other via the established connection. More specifically, for example, the information processing apparatus 101 can transmit, to the communication apparatus 151 via the established connection, a print job for causing the communication apparatus 151 to execute printing or a scan job for causing the communication apparatus 151 to execute scanning. Note that in this embodiment, it is possible to operate the communication apparatus 151 in the infrastructure connection mode and operate the communication apparatus 151 in the direct connection mode by the connection setting processing, but the present disclosure is not limited to this form. For example, it may be possible to only operate the communication apparatus 151 in the infrastructure connection mode (that is, it may be impossible to operate the communication apparatus 151 in the direct connection mode) by the connection setting processing.

### Connection Setting Mode

The communication apparatus 151 can operate in the connection setting mode. A trigger for the communication apparatus 151 to start an operation in the connection setting mode may be, for example, pressing a connection setting mode button by the user or activating (turning on) the communication apparatus 151 for the first time after arrival. The connection setting mode button may be a hardware button of the communication apparatus 151 or a software button displayed on the display unit 161 by the communication apparatus 151.

When the communication apparatus 151 starts an operation in the connection setting mode, it enables both Wi-Fi communication and BLE communication. More specifically, as Wi-Fi communication enabling processing, the communication apparatus 151 enables an internal AP (connection setting AP) of the communication apparatus 151 that is dedicated to the connection setting mode. Then, the communication apparatus 151 can establish direct connection to the information processing apparatus 101 by Wi-Fi. Connection information (SSID and password) for connection to the connection setting AP is held in advance in the predetermined application installed in the information processing apparatus 101. That is, the information processing apparatus 101 recognizes in advance the connection information for connection to the connection setting AP. Therefore, unlike the connection information of the AP enabled in the direct connection mode, the connection information for connection to the connection setting AP cannot be changed arbitrarily by the user. Note that a form in which an encryption method is not set for the connection setting AP and a password is unnecessary for connection to the AP may be adopted. Note that in the connection setting mode, the communication apparatus 151 may be connected to the information processing apparatus 101 by not normal Wi-Fi but Wi-Fi Direct (WFD). That is, the communication apparatus 151 may operate as a group owner and receive a setting command from the information processing apparatus 101 by WFD communication. If the communication apparatus 151 does not have the BLE communication function, in the operation in the connection setting mode, the communication apparatus 151 may enable only Wi-Fi communication.

### Registration of Communication Apparatus in Application

In this embodiment, the predetermined application of the information processing apparatus 101 can register the communication apparatus 151 in itself by acquiring information concerning the communication apparatus 151 from the communication apparatus 151. The information concerning the communication apparatus 151 is, for example, the capability information of the communication apparatus 151, the identification information (MAC address or the like) of the communication apparatus 151, the model information of the communication apparatus 151, or the like. More specifically, the capability information of the communication apparatus 151 includes a list of pieces of information of functions supported by the communication apparatus 151, the information of consumables (such as ink and sheets) usable by the communication apparatus 151, and information indicating the printing method (such as the inkjet printing method) of the communication apparatus 151. Then, the predetermined application selects one apparatus serving as the partner of communication by the predetermined application from the one or plurality of communication apparatuses 151 registered in the predetermined application. The communication apparatus 151 currently selected as the apparatus serving as the partner of communication by the predetermined application will be referred to as the currently selected communication apparatus 151 hereinafter. Note that the apparatus serving as the partner of communication by the predetermined application may be selected by accepting, from the user, selection from the one or plurality of communication apparatuses 151 registered in the predetermined application, or may automatically be selected by the predetermined application in accordance with a predetermined criterion. The apparatus serving as the partner of communication by the predetermined application may be changed by, for example, accepting, from the user, selection from the one or plurality of communication apparatuses 151 registered in the predetermined application. In this embodiment, the predetermined application transmits various kinds of jobs such as a print job and a scan job to the currently selected communication apparatus 151. That is, the currently selected communication apparatus 151 is an apparatus as the transmission destination of the various kinds of jobs.

Depending on the model of the communication apparatus 151 such as a printer, the optimal connection form to be desirably provided to the user may change. On the other hand, the predetermined application installed in the information processing apparatus 101 may be a model-independent application program that can support a plurality of models. If the predetermined application is a model-independent application program, there is a case where the model of the target of the connection setting processing cannot be specified in advance so a guidance according to the optimal connection form for the model of the target of the connection setting processing cannot be provided.

For example, the AP 156-a in the communication apparatus 151 may not have a Wide Area Network (WAN) function, unlike a wireless LAN router. In this case, if direct connection is established between the information processing apparatus 101 and the communication apparatus 151, the information processing apparatus 101 and the communication apparatus 151 cannot be connected to the Internet. In a case where the predetermined application executed by the information processing apparatus 101 is a model-independent application program, the model information of the communication apparatus 151 specified as the target of the connection setting processing is acquired from the external server. Accordingly, the information processing apparatus 101 needs to be connected to the Internet. However, if it cannot be connected to the Internet, a guidance according to the optimal connection form for the model of the target of the connection setting processing cannot be provided. In this embodiment, before the connection between the information processing apparatus 101 and the Internet is disconnected due to establishment of direct connection between the information processing apparatus 101 and the communication apparatus 151, the model information of the communication apparatus 151 is acquired from the server 171. With this, it is possible to provide a guidance according to the optimal connection form for the model of the target of the connection setting processing.

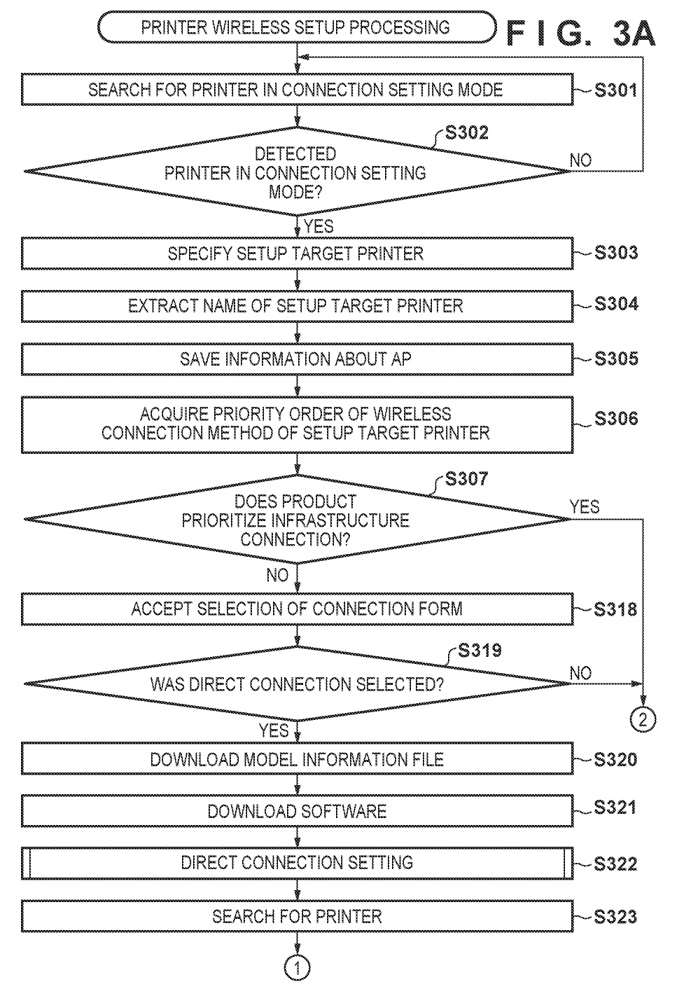

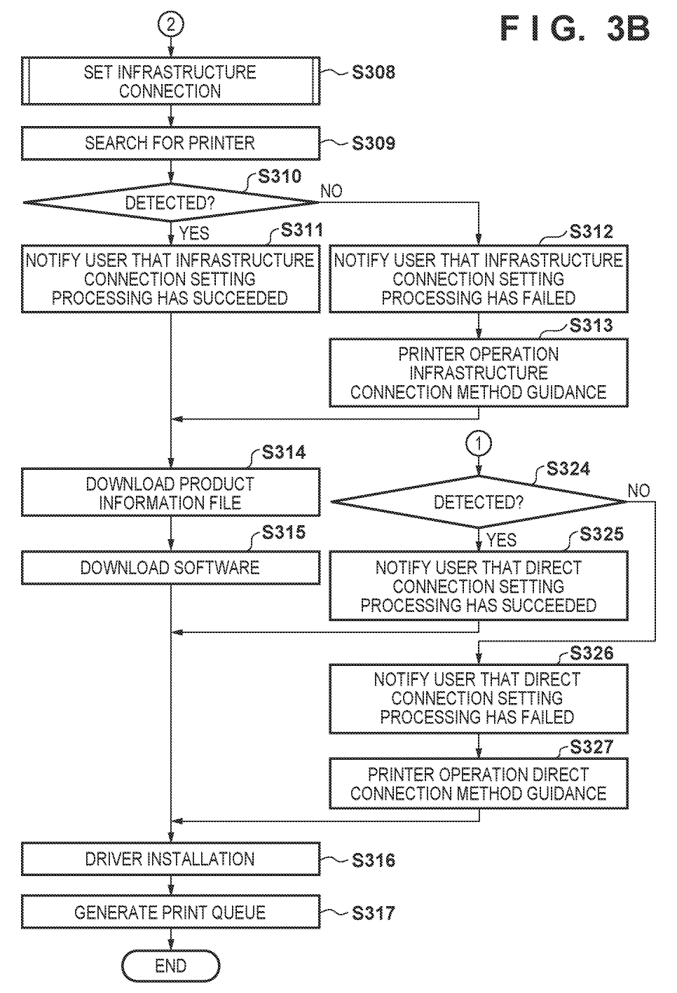

FIGS. 3A and 3B are flowcharts illustrating processing (to be referred to as wireless setup processing hereinafter) of wirelessly connecting the information processing apparatus 101 and the communication apparatus 151, which is executed by the information processing apparatus 101, according to this embodiment. This flowchart is implemented when, for example, the CPU 103 reads out the program stored in the ROM 104 into the RAM 105 and executes it. When the user executes a program (that is, the above-described predetermined application) for wireless setup processing included in the program by using the input interface 102 of the information processing apparatus 101, the CPU 103 starts the wireless setup processing illustrated in FIGS. 3A and 3B.

In step S301, the CPU 103 searches for the communication apparatus 151 targeted for the wireless setup processing. More specifically, for example, the CPU 103 uses the wireless communication unit 109 to search for a predetermined SSID (to be referred to as a connection setting SSID hereinafter) issued by the communication apparatus 151 operating in the connection setting mode. Note that, in this embodiment, the predetermined application holds a part of the character string of the connection setting SSID of the communication apparatus 151 operating in the connection setting mode before the wireless setup processing is executed. More specifically, for example, the predetermined application holds a character string "SETUP" included in the connection setting SSID before the wireless setup processing is executed.

In step S302, the CPU 103 determines whether the communication apparatus 151 operating in the connection setting mode is detected (discovered). More specifically, based on that the connection setting SSID is detected, the CPU 103 determines that the communication apparatus 151 operating in the connection setting mode is detected. If it is determined that the communication apparatus 151 operating in the connection setting mode is not detected, the processing from step S301 is repeated. On the other hand, if it is determined that the communication apparatus 151 operating in the connection setting mode is detected, in step S303, the CPU 103 specifies the detected communication apparatus 151 as the communication apparatus 151 targeted for the wireless setup processing. Note that if there are multiple communication apparatuses 151 operating in the connection setting mode around the communication apparatus 151, multiple connection setting SSIDs may be detected. In this case, the CPU 103 may display a list of the communication apparatuses 151 operating in the connection setting mode, and specify the communication apparatus 151 selected from the list by the user as the communication apparatus 151 targeted for the wireless setup processing. Alternatively, the CPU 103 may specify, as the communication apparatus 151 targeted for the wireless setup processing, the communication apparatus 151 issuing the first detected connection setting SSID among the multiple detected connection setting SSIDs.

In step S304, the CPU 103 extracts the model name of the communication apparatus 151 from the connection setting SSID issued by the communication apparatus 151. More specifically, for example, the CPU 103 extracts, as the model name of the communication apparatus 151, a character string from the beginning to the first underbar of the character string of the connection setting SSID. For example, if the connection setting SSID is "TSxxx_SETUP_mmnnn", "TSxxx" is extracted as the model name of the communication apparatus 151.

In step S305, the CPU 103 saves, in a memory such as the RAM 105, information concerning the AP 131 to which the information processing apparatus 101 is currently connected. More specifically, for example, the CPU 103 executes an Application Interface (API) of the Operating System (OS) for acquiring the SSID of the AP 131 to which the information processing apparatus 101 is currently connected to acquire the SSID of the AP 131 to which the information processing apparatus 101 is currently connected, and saves it in the memory such as the RAM 105.

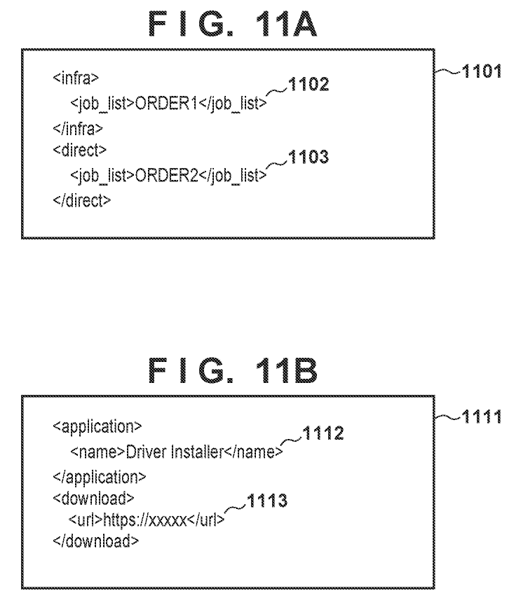

In step S306, based on the model name of the communication apparatus 151 extracted in step S304, the CPU 103 acquires, from the server 171, a file 1101 describing information about the priority order of the connection form of the communication apparatus 151 shown in FIG. 11A. More specifically, the CPU 103 transmits, to the server 171, the information indicating the model name of the communication apparatus 151 extracted in step S304. Then, based on the information, the server 171 specifies, from files 1101 corresponding to respective models, the file 1101 corresponding to the model name of the communication apparatus 151 extracted in step S304. The server 171 then transmits the file 1101 to the information processing apparatus 101 as a response to the information received from the information processing apparatus 101. Thus, the CPU 103 acquires the file 1101. The file 1101 describing information about the priority order of the connection form of the communication apparatus 151 describes a priority order 1102 of infrastructure connection and a priority order 1103 of direct connection of the communication apparatus 151. "ORDER1" described in the priority order 1102 of infrastructure connection indicates that infrastructure connection has the first priority, and "ORDER2" described in the priority order 1103 of direct connection indicates that direct connection has the second priority. Note that, as described above, the file 1101 is acquired from the server 171 in this embodiment, but this embodiment is not limited to this form. For example, the predetermined application may hold the files 1101 corresponding to the respective models in advance. Based on the information indicating the model name of the communication apparatus 151 extracted in step S304, the CPU 103 may specify and acquire the file 1101 corresponding to the model name from the files 1101. That is, the CPU 103 may acquire the file 1101 not from the server 171 but from the predetermined application.

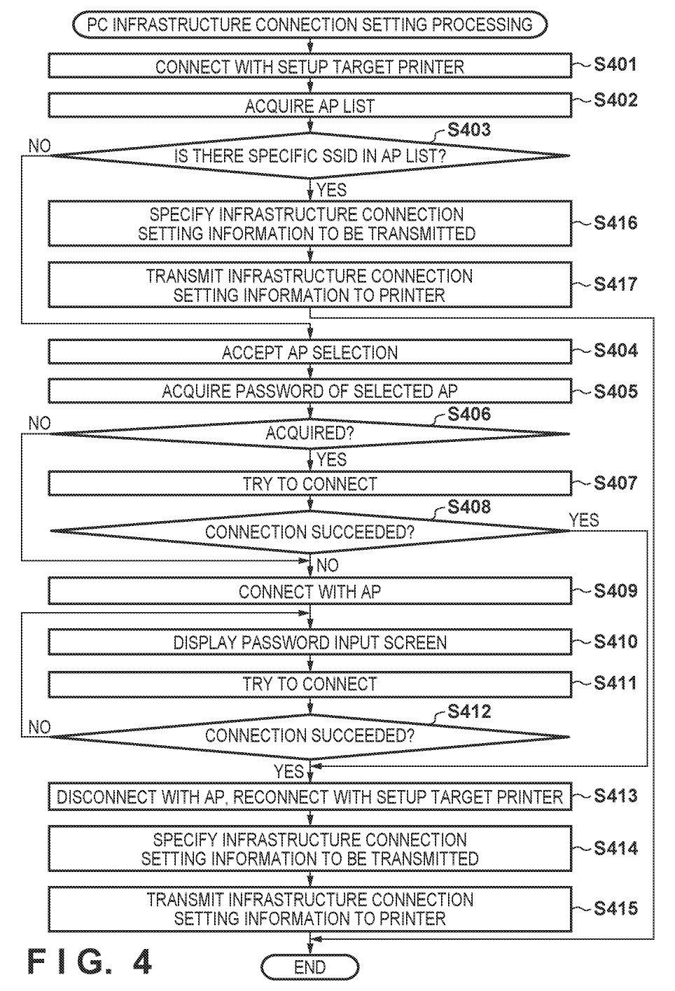

In step S307, from the file 1101 describing the information about the priority order of the connection form, which is acquired in step S306, the CPU 103 determines whether the model of the communication apparatus 151 is a model that prioritizes infrastructure connection (or a model that prioritizes direct connection). If it is determined that the model of the communication apparatus 151 is a model that prioritizes infrastructure connection, in step S308, the CPU 103 executes processing for establishing infrastructure connection with the communication apparatus 151 (to be referred to as infrastructure connection setting processing hereinafter). Note that the case where the model of the communication apparatus 151 is determined to be a model that prioritizes infrastructure connection corresponds to a case where the file 1101 indicates that the model of the communication apparatus 151 is a model that prioritizes infrastructure connection. The file 1101 is specified based on the model name of the communication apparatus 151 extracted in step S304. Therefore, the case where the model of the communication apparatus 151 is determined to be a model that prioritizes infrastructure connection corresponds to a case where the model name of the communication apparatus 151 extracted in step S304 (the contents of information extracted in step S304) corresponds to a model that prioritizes infrastructure connection. In other words, the case where the model of the communication apparatus 151 is determined to be a model that prioritizes infrastructure connection corresponds to a case where the file 1101 or the model name of the communication apparatus 151 extracted in step S304 corresponds to infrastructure connection. That is, the result of this determination is based on the contents of the model name of the communication apparatus 151 extracted in step S304. The infrastructure connection setting processing will be described later with reference to FIG. 4. Note that the form in which the file 1101 indicates whether the model of the communication apparatus 151 is a model that prioritizes infrastructure connection and determination based on the file 1101 is executed in step S307 is described above, but this embodiment is not limited to this form. For example, the CPU 103 may execute the determination based on the model name of the communication apparatus 151 extracted in step S304, without acquiring the file 1101. That is, for example, the CPU 103 may hold a white list corresponding to the model name of a model that prioritizes infrastructure connection. In this case, in step S307, the CPU 103 may determine whether the model name of the communication apparatus 151 extracted in step S304 is included in the white list. Alternatively, the CPU 103 may execute the determination in step S307 based on a white list corresponding to the model name of a model that prioritizes direct connection.

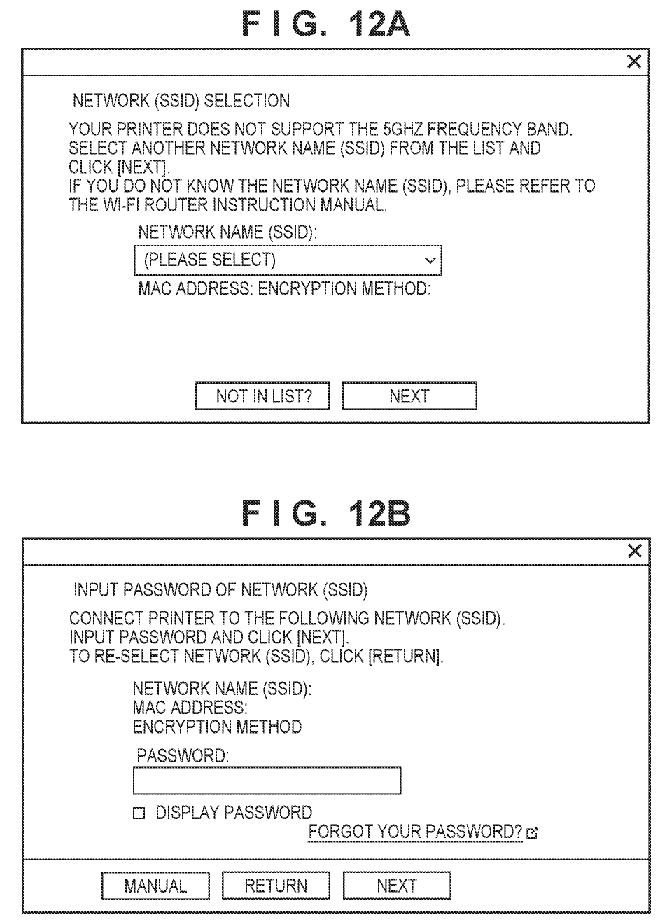

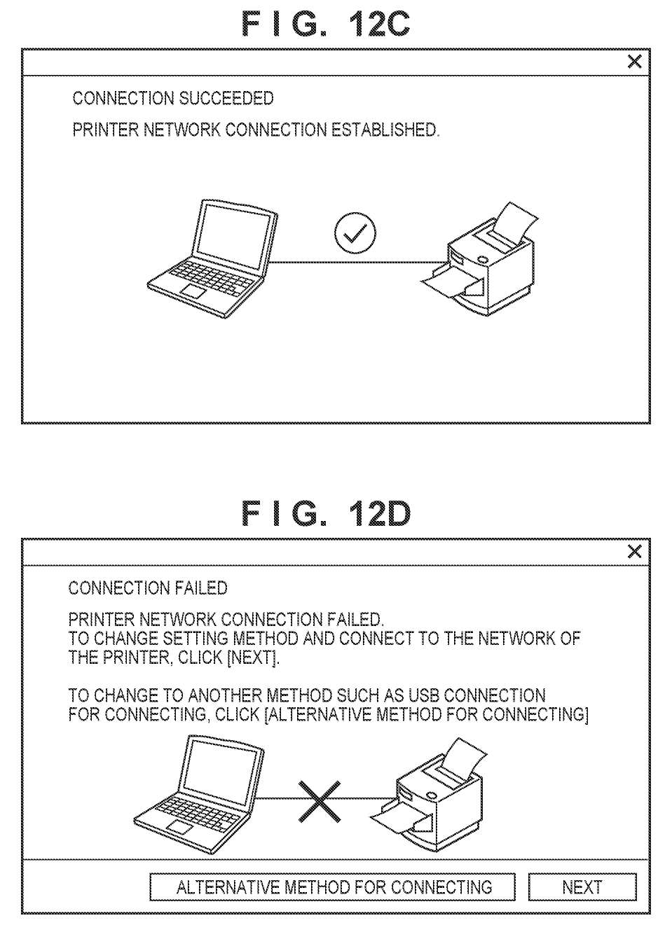

After step S308, in step S309, the CPU 103 searches for the communication apparatus 151 connected to the information processing apparatus 101 by infrastructure connection, and in step S310, the CPU 103 determines whether the communication apparatus 151 connected to the information processing apparatus 101 by infrastructure connection is detected. If the communication apparatus 151 connected to the information processing apparatus 101 by infrastructure connection is detected, the CPU 103 determines that the infrastructure connection setting processing has succeeded. Then, in step S311, the CPU 103 displays a success screen including the display contents shown in FIG. 12C on the display unit 108 to notify the user that the infrastructure connection setting processing has succeeded.

In step S314, the CPU 103 downloads, from the server 171, a model information file 1111 describing the model information of the communication apparatus 151 shown in FIG. 11B. The model information file 1111 describes a software name 1112 and a download URL 1113. The software name 1112 describes the name of each piece of software such as a driver installer used by the communication apparatus 151. The download URL 1113 describes a URL for downloading the software described in the software name 1112. Note that the model information file 1111 may also be downloaded in step S306. In step S315, the CPU 103 refers to the download URL 1113 of each piece of software described in the model information file 1111 downloaded in step S314, and downloads each piece of software including the driver installer. In this manner, since step S315 is executed after it is determined that the infrastructure connection setting processing has succeeded, unnecessary download processing can be prevented.

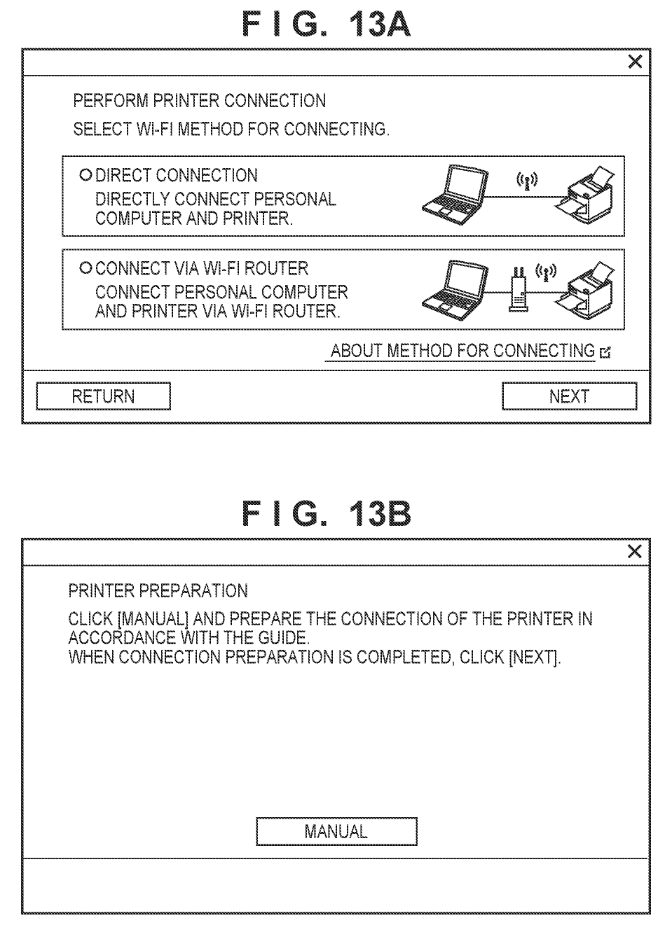

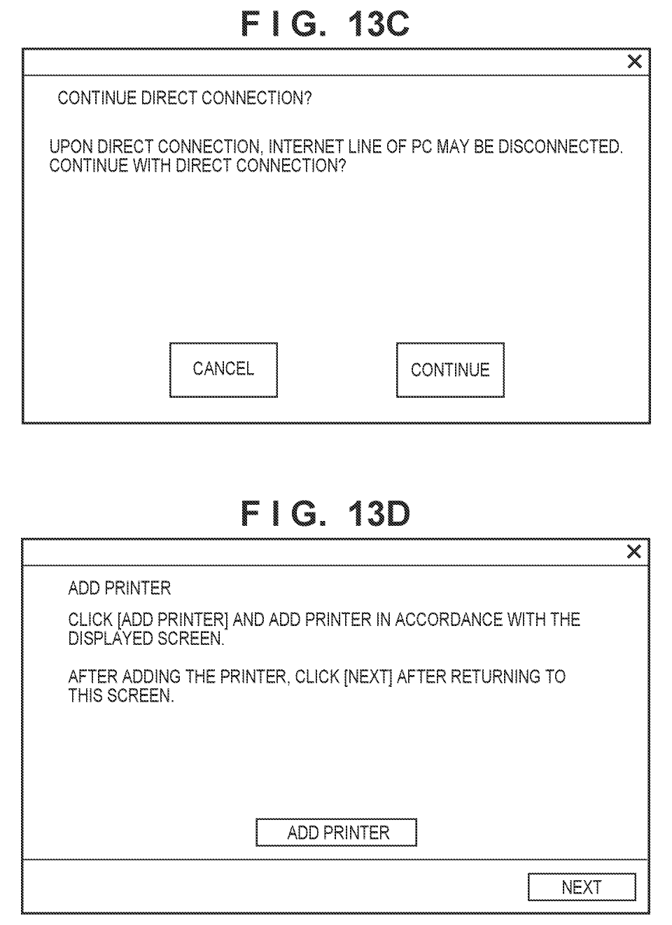

If it is determined in step S310 that the communication apparatus 151 connected to the information processing apparatus 101 by infrastructure connection is not detected, the CPU 103 determines that the infrastructure connection setting processing has failed and, in step S312, displays a failure screen including the display contents shown in FIG. 12D on the display unit 108 to notify the user that the infrastructure connection setting processing has failed. The failure screen displayed here includes a "next" button. If the "next" button on the failure screen is pressed by the user, the CPU 103 advances to step S313. In step S313, the CPU 103 displays, on the display unit 108, an infrastructure connection guidance screen for an operation on the communication apparatus 151, which includes the contents shown in FIG. 13B. The infrastructure connection guidance screen displayed here includes a "manual" button for displaying a manual showing a detailed explanation. If the "manual" button is pressed, the CPU 103 displays a Web manual page as an Internet content by a Web browser or the like. The Web manual page describes a method of connecting to the AP 131 via the wireless communication unit 156 of the communication apparatus 151 to establish infrastructure connection between the information processing apparatus 101 and the communication apparatus 151. Note that the method of connecting to the AP 131 via the wireless communication unit 156 of the communication apparatus 151 may be embedded and displayed on the infrastructure connection guidance screen. After step S313, the processing in steps S314 and S315 is executed. In this embodiment, it has been described that step S313 is executed after step S312. However, establishment of infrastructure connection between the information processing apparatus 101 and the communication apparatus 151 may fail even if the processing in step S313 is executed. Therefore, after step S312, the wireless setup processing illustrated in FIGS. 3A and 3B may be terminated without executing the processing from step S313.

In step S316, the CPU 103 executes the driver installer downloaded in step S315 to install the driver of the communication apparatus 151. After that, in step S317, the CPU 103 generates a print queue, and terminates the wireless setup processing illustrated in FIGS. 3A and 3B.

If it is determined in step S307 that the model of the communication apparatus 151 is not a model that prioritizes infrastructure connection (but a model that prioritizes direct connection), in step S318, the CPU 103 displays a wireless connection method selection screen including the display contents shown in FIG. 13A on the display unit 108. Then, the CPU 103 acquires the connection form of wireless connection to be established between the information processing apparatus 101 and the communication apparatus 151, which is selected by the user. The wireless connection method selection screen shown in FIG. 13A includes a radio button for selecting the connection form, and a "next" button. The wireless connection method selection screen is a screen that prompts the user to select the connection form of wireless connection to be established between the information processing apparatus 101 and the communication apparatus 151 and press the "next" button. If the "next" button is pressed, the CPU 103 determines in step S319 whether the connection form selected by the user on the wireless connection method selection screen is direct connection. If it is determined that direct connection is not selected, processing from step S308 to S317 is executed. After that, the CPU 103 terminates the wireless setup processing illustrated in FIGS. 3A and 3B. On the other hand, if it is determined that direct connection is selected, in step S320, the CPU 103 downloads the model information file 1111 describing the model information of the communication apparatus 151 from the server 171. The model information file 1111 describes the download URL of each piece of software such as the driver installer to be used by the communication apparatus 151. Note that, since the processing in steps S318 and S319 is executed after it is determined in step S307 that the model of the communication apparatus 151 is not a model that prioritizes infrastructure connection, the processing in step S320 may be directly executed without executing steps S318 and S319.

In this manner, in this embodiment, the model information of the communication apparatus 151 is acquired, and if it is determined that the model of the communication apparatus 151 prioritizes direct connection, a guidance screen for selecting the form of wireless connection is displayed in step S318. On the other hand, if it is determined that the model of the communication apparatus 151 prioritizes infrastructure connection, infrastructure connection setting processing is executed without displaying the guidance screen. With this, it is possible to control the display of the guidance screen while considering the priority of the wireless connection form for the model of the communication apparatus 151. Furthermore, if it is determined that the model of the communication apparatus 151 prioritizes direct connection, download processing from the server 171 via the Internet is executed before executing direct connection setting processing. With this, disconnection of the Internet connection due to establishment of direct connection is prevented, thereby preventing a failure of download processing.

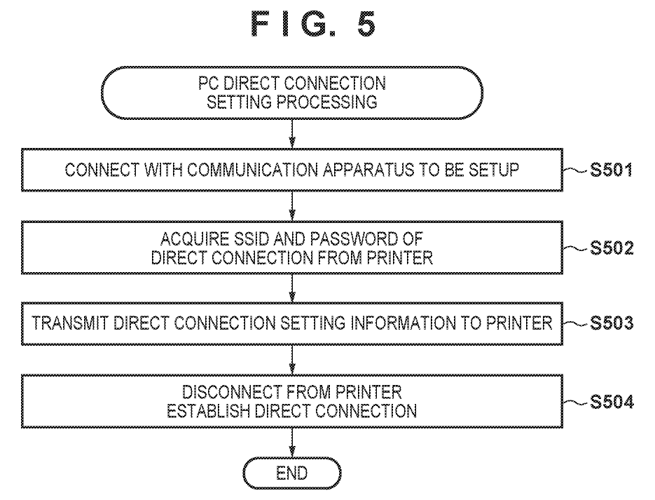

In step S321, the CPU 103 refers to the download URL of each piece of software described in the model information file 1111 downloaded in step S320 to download each piece of software including the driver installer. In step S322, the CPU 103 executes direct connection setting processing for connecting the information processing apparatus 101 to the direct connection AP of the communication apparatus 151. Direct connection setting processing will be described later with reference to FIG. 5. Note that the direct connection AP is an AP corresponding to the software AP described above, and this is different from the connection setting AP. In FIG. 2, the AP 156-a is shown as a single AP, but it can operate as both the direct connection AP and the connection setting AP.

After the processing in step S322, in step S323, the CPU 103 searches for the communication apparatus 151 connected to the information processing apparatus 101 by direct connection. In step S324, the CPU 103 determines whether the communication apparatus 151 connected to the information processing apparatus 101 by direct connection is detected (discovered) by the processing in step S323. If it is determined that the communication apparatus 151 connected to the information processing apparatus 101 by direct connection is detected, the CPU 103 determines that the direct connection setting processing has succeeded, and advances to step S325. In step S325, the CPU 103 displays a success screen including the display contents shown in FIG. 12C on the display unit 108 to notify the user that the direct connection setting processing has succeeded. After that, the processing in steps S316 and S317 is executed, and the CPU 103 then terminates the wireless setup processing illustrated in FIGS. 3A and 3B.

On the other hand, if it is determined that the communication apparatus 151 connected to the information processing apparatus 101 by direct connection is not detected, the CPU 103 determines that the direct connection setting processing has failed, and advances to step S326. In step S326, the CPU 103 displays a failure screen including the display contents shown in FIG. 12D on the display unit 108 to notify the user that the direct connection setting processing has failed. The failure screen displayed here is a screen that notifies the user that the direct connection setting processing has failed, and includes a "next" button. If the "next" button on the failure screen is pressed by the user, in step S327, the CPU 103 displays, on the display unit 108, a direct connection guidance screen for an operation on the communication apparatus 151, which includes the display contents shown in FIG. 13B. The direct connection guidance screen displayed here includes a "manual" button for displaying a manual showing a detailed explanation. If the "manual" button is pressed by the user, the CPU 103 displays a Web manual page as an Internet content by a Web browser or the like. The Web manual page describes a method of connecting the information processing apparatus 101 to the access point of the direct connection SSID issued by the communication apparatus 151. Note that the method of connecting the information processing apparatus 101 to the access point of the direct connection SSID issued by the communication apparatus 151 may be embedded and displayed on the direct connection guidance screen. After step S327, the processing in steps S316 and S317 is executed, and the wireless setup processing illustrated in FIGS. 3A and 3B is terminated. In this embodiment, it has been described that step S327 is executed after step S326. However, establishment of direct connection between the information processing apparatus 101 and the communication apparatus 151 may fail even if the processing in step S327 is executed. Therefore, after step S326, the wireless setup processing illustrated in FIGS. 3A and 3B may be terminated without executing the processing from step S327.

FIG. 4 is a flowchart of the infrastructure connection setting processing for the communication apparatus 151 executed by the information processing apparatus 101. This flowchart is implemented by, for example, the CPU 103 reading out a program stored in the ROM 104 to the RAM 105 and executing it. The processing illustrated in this flowchart corresponds to the processing in step S308.

In step S401, the CPU 103 establishes the wireless connection 143 between the information processing apparatus 101 and the communication apparatus 151 by setting the connection setting SSID as the SSID indicating the connection destination of the information processing apparatus 101. More specifically, for example, the CPU 103 executes an API of the OS to connect the information processing apparatus 101 to the AP 156-a corresponding to the connection setting SSID.

In step S402, the CPU 103 acquires an AP list from the communication apparatus 151. The AP list is a list of nearby APs detected by a search (AP search) executed by the communication apparatus 151. That is, the AP list is a list of nearby APs to which the communication apparatus 151 can be connected. More specifically, the AP list includes, for example, the SSID of each AP detected by a search for nearby beacons executed by the communication apparatus 151, and information of the encryption method used by each AP detected by the search for nearby beacons executed by the communication apparatus 151. The processing executed by the communication apparatus 151 in the processing in step S402 will be described later with reference to FIG. 6.

In step S403, the CPU 103 determines whether the SSID of the AP 131 to which the information processing apparatus 101 has been connected, that is saved in step S305, is included in the SSIDs shown in the AP list acquired in step S402. If it is determined that the saved SSID is not included, in step S404, the CPU 103 displays the AP list acquired in step S402 and accepts selection of one AP. In other words, selection of one AP is selection of one SSID. More specifically, for example, the CPU 103 displays an SSID selection screen including the display contents shown in FIG. 12A on the display unit 108. The SSID selection screen displayed here includes a pull-down menu and a "next" button. The SSID selection screen may also include a message indicating the reason why the SSID of the AP 131 to which the information processing apparatus 101 has been connected, that is saved in step S305, is not included in the SSIDs shown in the AP list acquired in step S402. For example, the message may indicate the reason that the communication apparatus 151 does not support communication using a 5-GHz frequency band. The pull-down menu is a menu that displays the SSIDs of the AP list acquired in step S402 when operated by the user. After selecting the pull-down menu, the user selects one SSID from the AP list. Until the user selects one SSID, the "next" button may be grayed out so it cannot be pressed by the user. If one SSID is selected by the user, the SSID selected by the user is displayed in the pull-down menu. Furthermore, the MAC address of the AP corresponding to the SSID selected by the user, and the encryption method used by the AP corresponding to the SSID selected by the user are displayed in the SSID selection menu. After that, if the user presses the "next" button enabled by selecting one SSID, the CPU 103 advances to step S405.

In step S405, the CPU 103 tries to acquire a password for connecting to the AP corresponding to the SSID selected in step S404 from a wireless profile saved by the OS of the information processing apparatus 101. The CPU 103 executes an API for acquiring a password from the wireless profile, thereby acquiring the password for connecting to the AP corresponding to the SSID selected in step S404 from the wireless profile saved by the OS of the information processing apparatus 101. After that, in step S406,the CPU 103 determines whether it can acquire the password for connecting to the AP corresponding to the SSID selected in step S404 from the wireless profile saved by the OS of the information processing apparatus 101. In a case where the AP corresponding to the SSID selected in step S404 and the information processing apparatus 101 have been connected to each other via the wireless LAN in the past, and the wireless profile corresponding to the SSID selected in step S404 is saved by the OS of the information processing apparatus 101, the password for connecting to the AP corresponding to the SSID selected in step S404 is successfully acquired. On the other hand, in a case where the AP corresponding to the SSID selected in step S404 and the information processing apparatus 101 have not been connected to each other via the wireless LAN in the past, or in a case where the AP corresponding to the SSID selected in step S404 and the information processing apparatus 101 have been connected to each other via the wireless LAN in the past but the wireless profile corresponding to the SSID selected in step S404 has been deleted, the password for connecting to the AP corresponding to the SSID selected in step S404 is failed to be acquired. If it is determined that the password is successfully acquired, the CPU 103 advances to step S407. If it is determined that the password is failed to be acquired, the CPU 103 advances to step S409.

In step S407, the CPU 103 disconnects the connection to the AP corresponding to the connection setting SSID of the communication apparatus 151, and tries to establish wireless connection between the information processing apparatus 101 and the AP corresponding to the SSID selected in step S404 by using the password acquired in step S405. More specifically, for example, the CPU 103 executes an API of the OS to disconnect the connection to the AP corresponding to the connection setting SSID and try to connect to the AP corresponding to the SSID selected in step S404. In step S408, the CPU 103 determines whether wireless connection between the information processing apparatus 101 and the AP corresponding to the SSID selected in step S404 is successfully established by the connection trial in step S407. If it is determined that the wireless connection is successfully established, the CPU 103 advances to step S413. On the other hand, if it is determined that the wireless connection is not successfully established, in step S409, the CPU 103 disconnects the connection to the AP corresponding to the connection setting SSID, and establishes again the wireless connection 141 between the AP 131 and the information processing apparatus 101 by using the information saved in step S305. More specifically, for example, the CPU 103 executes an API of the OS to establish the wireless connection 141 between the AP 131 and the information processing apparatus 101.

In step S410, the CPU 103 displays a password input screen including the display contents shown in FIG. 12B on the display unit 108, and accepts an input of the password for connecting to the AP corresponding to the SSID selected in step S404. The password input screen shown in FIG. 12B includes the information of the SSID selected in step S404, a password input box, a check box, and a "manual" button. The password input box is a box for accepting, from the user, an input of the password for connecting to the AP corresponding to the SSID selected in step S404. The check box is a box for switching whether the character string of the password input in the password input box is displayed as intact or with asterisks as blank characters. The "manual" button is a button capable of accepting an operation serving as a trigger of processing for displaying a Web manual for presenting a password check method to the user as an Internet content by a Web browser or the like. When the password is input in the password input box, the "next" button is enabled and can be pressed by the user. If the "next" button is pressed, the CPU 103 advances to step S411. In step S411, the CPU 103 disconnects the wireless connection 141 established in step S409, and tries to establish wireless connection between the information processing apparatus 101 and the AP corresponding to the SSID selected in step S404 by using the password input on the password input screen. More specifically, for example, the CPU 103 executes an API of the OS to disconnect the wireless connection 141 with the AP 131 and try to connect to the AP corresponding to the SSID selected in step S404. In step S412, the CPU 103 determines whether the connection between the information processing apparatus 101 and the AP corresponding to the SSID selected in step S404 is successfully established by the connection trial executed in step S411. If it is determined that the connection is not successfully established, the processing from step S410 is repeated. On the other hand, if it is determined that the connection is successfully established, in step S413, the CPU 103 disconnects the wireless connection between the information processing apparatus 101 and the AP corresponding to the SSID selected in step S404, and connects the information processing apparatus 101 again to the AP corresponding to the connection setting SSID issued by the communication apparatus 151. More specifically, for example, the CPU 103 executes an API of the OS to disconnect the wireless connection to the AP corresponding to the SSID selected in step S404 and connect the information processing apparatus 101 and the AP corresponding to the connection setting SSID. In step S414, as connection setting information to be transmitted to the communication apparatus 151 specified in step S303, the CPU 103 specifies the SSID selected in step S404 and the password acquired in step S405 or S410. Note that in this embodiment, other information such as the frequency band or encryption method used by the AP corresponding to the SSID selected in step S404 may be specified. In step S415, the CPU 103 transmits the infrastructure connection setting information for setting an infrastructure connection mode to the communication apparatus 151. After that, the CPU 103 terminates the infrastructure connection setting processing illustrated in FIG. 4. The infrastructure connection setting information includes a command instructing the communication apparatus 151 to operate in the infrastructure connection mode, and the connection setting information specified in step S414.

If it is determined in step S403 that the SSID of the AP 131 saved in step S305 is included in the SSIDs shown in the AP list acquired in step S402, in step S416, the CPU 103 specifies connection setting information to be transmitted to the communication apparatus 151 specified in step S303. More specifically, for example, the CPU 103 specifies the SSID and password of the AP 131 saved in step S305 as the connection setting information. In step S417, the CPU 103 transmits the infrastructure connection setting information for setting the infrastructure connection mode to the communication apparatus 151. After that, the CPU 103 terminates the infrastructure connection setting processing illustrated in FIG. 4. The infrastructure connection setting information includes a command instructing the communication apparatus 151 to operate in the infrastructure connection mode, and the connection setting information specified in step S416. Note that in this embodiment, other information such as the frequency band or encryption method used by the AP 131 corresponding to the SSID selected in step S305 may be specified. Note that any information specified here is included in the information saved in step S305.

FIG. 5 is a flowchart of the direct connection setting processing for the communication apparatus 151 executed by the information processing apparatus 101. This flowchart is implemented by, for example, the CPU 103 reading out a program stored in the ROM 104 to the RAM 105 and executing it. The processing illustrated in this flowchart corresponds to the processing in step S322.

In step S501, the CPU 103 establishes the wireless connection 143 between the information processing apparatus 101 and the communication apparatus 151 by setting the connection setting SSID detected in step S303 as the SSID indicating the connection destination of the information processing apparatus 101. In step S502, the CPU 103 acquires a direct connection SSID and a password for connecting to the direct connection SSID from the communication apparatus 151. The processing executed by the communication apparatus 151 in the processing in step S502 will be described later with reference to FIG. 6.

In step S503, the CPU 103 transmits the direct connection setting information for setting the direct connection mode to the communication apparatus 151 specified in step S303. In step S504, the CPU 103 disconnects the connection between the information processing apparatus 101 and the AP corresponding to the connection setting SSID, and establish direct connection between the information processing apparatus 101 and the AP corresponding to the direct connection SSID. More specifically, for example, the CPU 103 executes an API of the OS to disconnect the connection between the information processing apparatus 101 and the AP corresponding to the direct connection setting SSID, and establish connection between the information processing apparatus 101 and the AP corresponding to the direct connection SSID. After that, the direct connection setting processing illustrated in FIG. 5 is terminated.

FIG. 6 is a flowchart of the connection setting processing executed by the communication apparatus 151. This flowchart is implemented by, for example, the CPU 154 reading out a program stored in the ROM 152 to the RAM 153 and executing it.

If the information processing apparatus 101 is connected to the AP corresponding to the connection setting SSID and the wireless connection 143 is established, the CPU 154 checks in step S601 whether there is an AP list acquisition request from the information processing apparatus 101. Step S601 is processing corresponding to step S402 of FIG. 4. In step S602, the CPU 154 determines whether there is an AP list acquisition request from the information processing apparatus 101. If it is determined that there is an AP list acquisition request, in step S603, the CPU 154 searches for nearby beacons by using the wireless communication unit 156, acquires SSID information included in the discovered beacon, and generates an AP list based on the acquired SSID information. In step S604, the CPU 154 transmits the AP list generated in step S603 to the information processing apparatus 101 that has made the request. After step S604, the processing from step S601 is repeated.

If it is determined in step S602 that there is no AP list acquisition request from the information processing apparatus 101, the CPU 154 checks in step S605 whether there is a direct connection information acquisition request from the information processing apparatus 101. Step S605 is processing corresponding to step S502 of FIG. 5. The direct connection information requested to acquire is information including the direct connection SSID, and a password for connecting the information processing apparatus 101 to the AP corresponding to the direct connection SSID. In step S606, the CPU 154 determines whether there is a direct connection information acquisition request from the information processing apparatus 101. If it is determined that there is a direct connection information acquisition request, in step S607, the CPU 154 transmits the direct connection information to the information processing apparatus 101 which has made the request. After step S607, the processing from step S601 is repeated.

On the other hand, if it is determined that there is no direct connection information acquisition request, the CPU 154 checks in step S608 whether connection setting information is received from the information processing apparatus 101. The connection setting information here is infrastructure connection setting information or direct connection setting information. In step S609, the CPU 154 determines whether connection setting information is received from the information processing apparatus 101. If it is determined that no connection setting information is received, the processing from S601 is repeated.

On the other hand, if it is determined that connection setting information is received, the CPU 154 determines in step S610 whether the connection setting information received from the information processing apparatus 101 is infrastructure connection setting information. If it is determined that the connection setting information received from the information processing apparatus 101 is infrastructure connection setting information, in step S611, the CPU 154 changes the operation mode of the communication apparatus 151 from the connection setting mode to the infrastructure connection mode. After that, the CPU 154 terminates the connection setting processing illustrated in FIG. 6. More specifically, for example, the CPU 154 disables the AP 156-a having the connection setting SSID by terminating the connection setting mode. Then, the CPU 154 acquires an SSID included in connection setting information for setting the infrastructure connection mode, which is transmitted from the information processing apparatus 101, and connects to the AP corresponding to the SSID. When the communication apparatus 151 establishes the wireless LAN connection 142, the communication apparatus 151 and the information processing apparatus 101 can be connected by infrastructure connection. On the other hand, if it is determined that the connection setting information received from the information processing apparatus 101 is not infrastructure setting information, in step S612, the CPU 154 changes the operation mode of the communication apparatus 151 from the connection setting mode to the direct connection mode. After that, the CPU 154 terminates the connection setting processing illustrated in FIG. 6. More specifically, for example, the CPU 154 disables the AP 156-a having the connection setting SSID by terminating the connection setting mode. After that, the CPU 154 starts the direct connection mode to enable the AP 156-a having the direct connection SSID corresponding to the direct connection mode. With this, the information processing apparatus 101 can connect to the AP 156-a having the direct connection SSID issued by the communication apparatus 151.

In this manner, according to this embodiment, the model information of the communication apparatus 151 is acquired, and if it is determined that the model of the communication apparatus 151 prioritizes direct connection, a guidance screen for selecting the form of wireless connection is displayed. On the other hand, if it is determined that the model of the communication apparatus 151 prioritizes infrastructure connection, infrastructure connection setting processing is executed without displaying the guidance screen. With this, it is possible to control the display of the guidance screen while considering the priority of the wireless connection form for the communication apparatus 151 targeted for the connection setting processing. In addition, the information processing apparatus 101 performs download processing from the server 171 via the Internet before establishing direct connection between the information processing apparatus 101 and the communication apparatus 151. With this, the information processing apparatus 101 can prevent a failure of download processing from the server 171 that occurs when it cannot be connected to the Internet due to establishment of direct connection.

### Second Embodiment

The second embodiment will be described below concerning differences from the first embodiment. In the first embodiment, the configuration has been described in which the information processing apparatus 101 performs the necessary processing via the Internet before establishing direct connection with the communication apparatus 151. In this embodiment, a configuration will be described in which an information processing apparatus 101 determines whether the environment is such that the connection to the Internet is disconnected due to establishment of direct connection with a communication apparatus 151, and controls wireless setup processing according to the determination result.

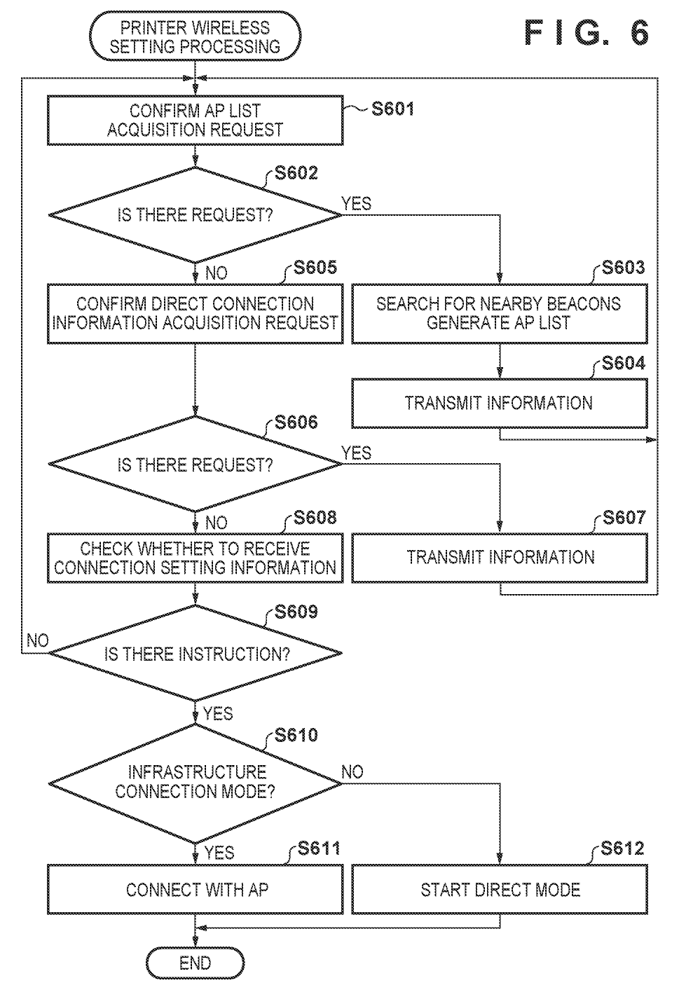

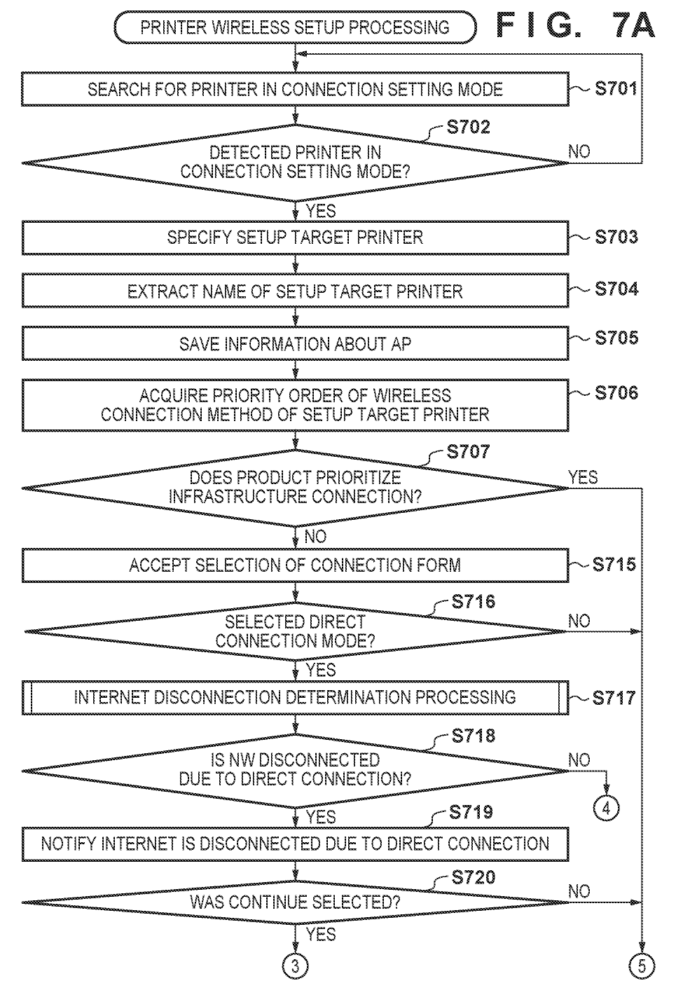

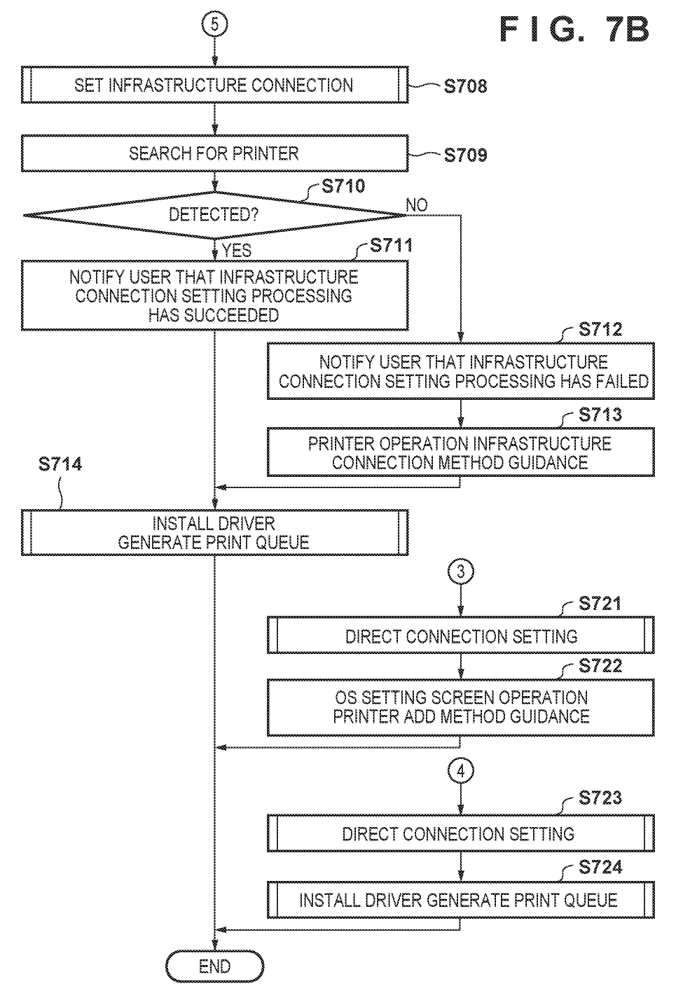

With reference to FIGS. 7A and 7B, the wireless setup processing executed by the information processing apparatus 101 in this embodiment will be described. The wireless setup processing illustrated in FIGS. 7A and 7B is implemented by, for example, a CPU 103 reading out a program stored in a ROM 104 to a RAM 105 and executing it. The wireless setup processing illustrated in FIGS. 7A and 7B is started when, for example, the user executes a predetermined application using an input interface 102 of the information processing apparatus 101.

Since processing from step S701 to step S713 in FIGS. 7A and 7B is similar to that from step S301 to step S313, a description thereof will be omitted.

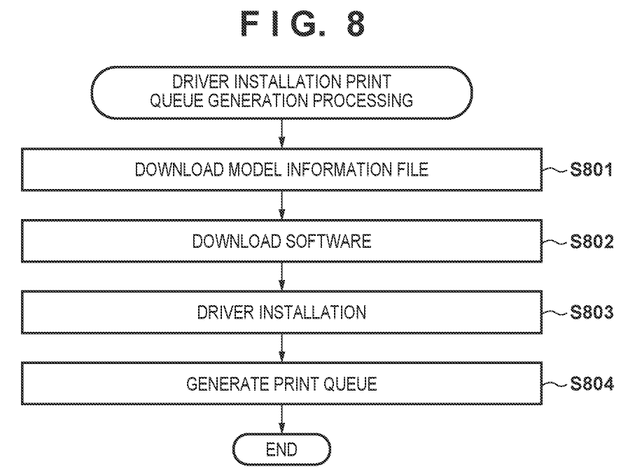

After the processing in step S711 or S713, the CPU 103 executes the driver installation processing and print queue generation processing in step S714, and terminates the wireless setup processing illustrated in FIGS. 7A and 7B. The driver installation processing and print queue generation processing will be described later with reference to FIG. 8.

If it is determined in step S707 that the model of the communication apparatus 151 is not a model that prioritizes infrastructure connection (but a model that prioritizes direct connection), the processing in steps S715 and S716 is executed. Since steps S715 and S716 are similar to steps S318 and S319, respectively, a description thereof will be omitted. If it is determined in step S716 that direct connection is not selected, the processing from S708 to S714 is executed. After that, the wireless setup processing illustrated in FIGS. 7A and 7B is terminated.

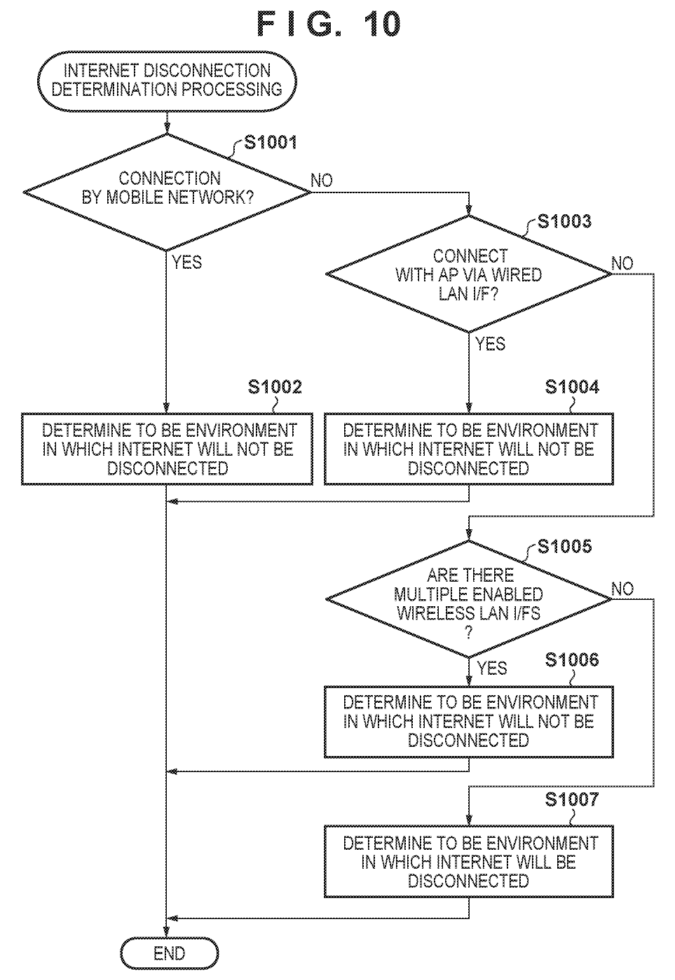

On the other hand, if it is determined in step S716 that direct connection is selected, in step S717, the CPU 103 executes processing of determining whether the environment is such that the Internet connection of the information processing apparatus 101 is disconnected due to establishment of direct connection between the information processing apparatus 101 and the communication apparatus 151 (to be referred to as Internet disconnection determination processing hereinafter). The Internet disconnection determination processing will be described later with reference to FIG. 10.

After step S717, the CPU 103 determines in step S718 whether the environment is such that the Internet connection of the information processing apparatus 101 is not disconnected due to establishment of direct connection between the information processing apparatus 101 and the communication apparatus 151. If it is determined that the environment is such that the Internet connection of the information processing apparatus 101 is not disconnected due to establishment of direct connection between the information processing apparatus 101 and the communication apparatus 151, the CPU 103 executes the direct connection setting processing in step S723. The direct connection setting processing will be described later with reference to FIG. 10. After step S723, the CPU 103 executes the driver installation processing and the print queue generation processing in step S724. After that, the CPU 103 terminates the wireless setup processing illustrated in FIGS. 7A and 7B. The driver installation processing and the print queue generation processing will be described later with reference to FIG. 8.

On the other hand, if it is determined that the environment is such that the Internet connection of the information processing apparatus 101 is disconnected due to establishment of direct connection between the information processing apparatus 101 and the communication apparatus 151, in step S719, the CPU 103 displays an Internet disconnection notification screen including the display contents shown in FIG. 13C on a display unit 108. The Internet disconnection notification screen includes a message notifying that the Internet connection is disconnected due to establishment of direct connection between the information processing apparatus 101 and the communication apparatus 151, a message confirming whether to establish direct connection between the information processing apparatus 101 and the communication apparatus 151, a "continue" button, and a "cancel" button. If the "continue" button or the "cancel button" is pressed, the CPU 103 advances to step S720.

In step S720, the CPU 103 determines whether the button pressed by the user on the Internet disconnection notification screen displayed in step S719 is the "continue" button. If it is determined that the button pressed by the user is not the "continue" button, the processing from step S708 to step S714 is executed, and the wireless setup processing illustrated in FIGS. 7A and 7B is terminated. Note that the processing in steps S719 and S720 is executed only if it is determined that the Internet connection is disconnected. Therefore, if disconnection of the Internet connection of the information processing apparatus 101 is undesirable, the processing from step S708 to step S714 may be executed without executing steps S719 and S720.

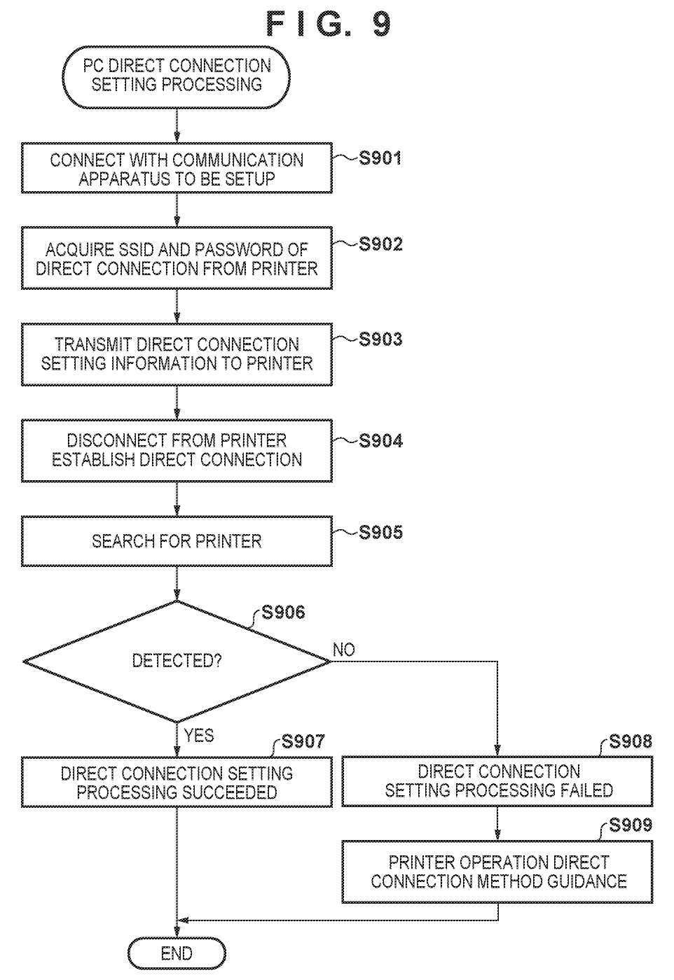

If it is determined that the button pressed by the user in step S720 is the "continue" button, the CPU 103 executes the direct connection setting processing in step S721. The direct connection setting processing will be described later with reference to FIG. 9. After that, in step S722, the CPU 103 displays a printer addition screen including the display contents shown in FIG. 13D, thereby notifying driver installation and print queue generation by an operation on a OS setting screen. The printer addition screen includes a "add printer" button and a "next" button. If the "add printer" button is pressed, a Web manual page is displayed as the OS setting screen and Internet content by a Web browser or the like. The Web manual page is a screen for guiding a procedure of adding a printer by an operation on the OS setting screen. When the "add printer" button is pressed, the "next" button is enabled and can be pressed by the user. If the "next" button is pressed, the printer wireless setup processing illustrated in FIGS. 7A and 7B is terminated.

With reference to FIG. 8, the driver installation processing and the print queue generation processing executed by the information processing apparatus 101 in this embodiment will be described. This flowchart is implemented by, for example, the CPU 103 reading out a program stored in the ROM 104 to the RAM 105 and executing it. The processing illustrated in this flowchart corresponds to the processing in each of steps S714 and S724.

If the driver installation processing is started, the CPU 103 executes the processing from step S801 to step S804. Since the processing from step S801 to step S804 is similar to that from step S314 to step S317, a description thereof will be omitted. After step S804, the driver installation processing illustrated in FIG. 8 is terminated.

FIG. 9 is a flowchart of the direct connection setting processing for the communication apparatus 151 executed by the information processing apparatus 101. This flowchart is implemented by, for example, the CPU 103 reading out a program stored in the ROM 104 to the RAM 105 and executing it. The processing illustrated in this flowchart corresponds to the processing in each of steps S721 and S723.

Since steps S901 to S904 and steps S905 to S909 are similar to steps S501 to S504 and steps S323 to S327, respectively, a description thereof will be omitted. After step S909, the direct connection setting processing illustrated in FIG. 9 is terminated.

FIG. 10 is a flowchart of the Internet disconnection determination processing executed by the information processing apparatus 101. This flowchart is implemented by, for example, the CPU 103 reading out a program stored in the ROM 104 to the RAM 105 and executing it. The processing illustrated in this flowchart corresponds to the processing in step S717.

In step S1001, the CPU 103 determines whether the information processing apparatus 101 is connected to the Internet by a mobile network. More specifically, for example, the CPU 103 executes an API of the OS to determine whether the information processing apparatus 101 is connected to the Internet by a mobile network. If it is determined that the information processing apparatus 101 is connected to the Internet by a mobile network, the CPU 103 determines in step S1002 that the Internet connection will not be not disconnected even if direct connection is established between the information processing apparatus 101 and the communication apparatus 151. After that, the CPU 103 terminates the Internet disconnection determination processing illustrated in FIG. 10. This determination result is saved in a predetermined storage area so that the CPU 103 can acquire it in the later processing.

On the other hand, if it is determined that the information processing apparatus 101 is not connected to the Internet by a mobile network, the CPU 103 determines in step S1003 whether the information processing apparatus 101 is connected to the Internet by wired connection by a wired communication unit 112. More specifically, for example, the CPU 103 executes an API of the OS to acquire information on whether the wired communication unit 112 is enabled and connected to the Internet. If it is determined that the information processing apparatus 101 is connected to the Internet by wired connection by the wired communication unit 112, the CPU 103 determines in step S1004 that the environment is such that the Internet connection is not disconnected even if direct connection is established between the information processing apparatus 101 and the communication apparatus 151. After that, the CPU 103 terminates the Internet disconnection determination processing illustrated in FIG. 10. This determination result is saved in a predetermined storage area so that the CPU 103 can acquire it in the later processing.

On the other hand, if it is determined that the information processing apparatus 101 is not connected to the Internet by wired connection by the wired communication unit 112, the CPU 103 determines in step S1005 whether there are a plurality of enabled wireless communication units 109. More specifically, for example, the CPU 103 executes an API of the OS to acquire the number of enabled wireless communication units 109. If it is determined that there are a plurality of enabled wireless communication units 109, the CPU 103 determines in step S1006 that the environment is such that the Internet connection is not disconnected even if direct connection is established between the information processing apparatus 101 and the communication apparatus 151. After that, the CPU 103 terminates the Internet disconnection determination processing illustrated in FIG. 10. This determination result is saved in a predetermined storage area so that the CPU 103 can acquire it in the later processing.

On the other hand, if it is determined that there are not a plurality of enabled wireless communication units 109, the CPU 103 determines in step S1007 that the environment is such that the Internet connection is disconnected if direct connection between the information processing apparatus 101 and the communication apparatus 151 is established. After that, the CPU 103 terminates the Internet disconnection determination processing illustrated in FIG. 10. This determination result is saved in a predetermined storage area so that the CPU 103 can acquire it in the later processing.

In this manner, according to this embodiment, it is determined whether the environment is such that the Internet connection is disconnected due to establishment of direct connection between the information processing apparatus 101 and the communication apparatus 151, and the wireless setup processing is controlled based on the determination result. With this, it is possible to display the Internet disconnection notification screen shown in FIG. 13C for the user only when the Internet connection is likely to be disconnected.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-160326, filed September 17, 2024 which is hereby incorporated by reference herein in its entirety.

What is claimed is:

1. A control method comprising:
performing setting of wireless connection of a communication apparatus to enable communication between an information processing apparatus and the communication apparatus;
acquiring information corresponding to a model name of the communication apparatus from the communication apparatus targeted for setting of wireless connection of the communication apparatus; and
controlling to
execute, based on that the acquired information corresponding to the model name of the communication apparatus is first contents, predetermined processing for establishing direct connection which directly connects the information processing apparatus and the communication apparatus, and
execute, based on that the acquired information corresponding to the model name of the communication apparatus is second contents different from the first contents, processing for establishing infrastructure connection which connects the information processing apparatus and the communication apparatus via an external apparatus different from the information processing apparatus and the communication apparatus without executing the predetermined processing.

2. The method according to claim 1, further comprising
executing, based on that the acquired information corresponding to the model name of the communication apparatus is the first contents, processing via an external network before establishing the direct connection.

3. The method according to claim 2, wherein
the processing via the external network is downloading of software from a server.

4. The method according to claim 3, wherein
the software includes a driver installer.

5. The method according to claim 1, further comprising
determining, based on that the acquired information corresponding to the model name of the communication apparatus is the first contents, whether connection between the information processing apparatus and an external network is disconnected due to establishment of the direct connection.

6. The method according to claim 5, wherein
in a case where it is determined that the connection between the information processing apparatus and the external network is not disconnected, the direct connection is set as wireless connection of the communication apparatus.

7. The method according to claim 5, further comprising
notifying that the connection is disconnected, in a case where it is determined that the connection between the information processing apparatus and the external network is disconnected.

8. The method according to claim 7, wherein
the notifying is performed on a screen that can accept each of an instruction to execute the direct connection and an instruction not to execute the direct connection.

9. The method according to claim 8, wherein
in a case where an instruction to execute the direct connection is accepted on the screen, the direct connection is set as wireless connection of the communication apparatus.

10. The method according to claim 8, wherein
in a case where an instruction not to execute the direct connection is accepted on the screen, the infrastructure connection is set as wireless connection of the communication apparatus.

11. The method according to claim 1, wherein
information corresponding to a model name of the communication apparatus is acquired from a Service Set Identifier (SSID) of a predetermined access point of the communication apparatus.

12. The method according to claim 1, further comprising
acquiring, based on the acquired information corresponding to the model name of the communication apparatus, information about a form of wireless connection to be established to perform communication between the information processing apparatus and the communication apparatus,
wherein, based on that the form of wireless connection indicated by the acquired information is the direct connection, the predetermined processing is executed, and
based on that the form of wireless connection indicated by the acquired information is not the direct connection, processing for establishing the infrastructure connection is executed without executing the predetermined processing.

13. The method according to claim 12, wherein
information about the form of wireless connection is acquired from a server via an external network.

14. The method according to claim 13, wherein
a file describing information about the form of wireless connection is acquired from the server.

15. The method according to claim 14, wherein
the file describes a plurality of forms of wireless connection of the communication apparatus corresponding to the model name of the communication apparatus in an order of priority.

16. The method according to claim 1, wherein
the predetermined processing is displaying a screen that prompts a user to select a form of wireless connection to be established by the communication apparatus, and
the screen includes the direct connection as a choice of the form of wireless connection.

17. The method according to claim 1, wherein
the communication apparatus is a printer including a printing unit.

18. The method according to claim 1, wherein
the external apparatus is an access point outside the information processing apparatus and the communication apparatus.

19. An information processing apparatus comprising
at least one memory and at least one processor which function as:
a connection setting unit configured to perform setting of wireless connection of a communication apparatus to enable communication between the information processing apparatus and the communication apparatus;
a first acquisition unit configured to acquire information corresponding to a model name of the communication apparatus from the communication apparatus targeted for setting of wireless connection of the communication apparatus; and
a control unit configured to control to
execute, based on that the information corresponding to the model name of the communication apparatus acquired by the first acquisition unit is first contents, predetermined processing for establishing direct connection which directly connects the information processing apparatus and the communication apparatus, and
execute, based on that the information corresponding to the model name of the communication apparatus acquired by the first acquisition unit is second contents different from the first contents, processing for establishing infrastructure connection which connects the information processing apparatus and the communication apparatus via an external apparatus different from the information processing apparatus and the communication apparatus without executing the predetermined processing.

20. A non-transitory computer-readable storage medium that stores one or more programs including instructions, which when executed by one or more processors of an information processing apparatus, cause the information processing apparatus to execute a method:
the method comprising:
performing setting of wireless connection of a communication apparatus to enable communication between the information processing apparatus and the communication apparatus;
acquiring information corresponding to a model name of the communication apparatus from the communication apparatus targeted for setting of wireless connection of the communication apparatus; and
controlling to
execute, based on that the acquired information corresponding to the model name of the communication apparatus is first contents, predetermined processing for establishing direct connection which directly connects the information processing apparatus and the communication apparatus, and
execute, based on that the acquired information corresponding to the model name of the communication apparatus is second contents different from the first contents, processing for establishing infrastructure connection which connects the information processing apparatus and the communication apparatus via an external apparatus different from the information processing apparatus and the communication apparatus without executing the predetermined processing.
